(19) United States
(12) Patent Application Publication
(10) Pub. No.: US 2026/0254943 A1
(43) Pub. Date: Aug. 27, 2026

(54) COMPOUND WARP INTER-INTRA PREDICTION

(71) Applicant: GOOGLE LLC, Mountain View, CA (US)

(72) Inventors: Mohammed Golam Sarwer, San Jose, CA (US); Debargha Mukherjee, Cupertino, CA (US); Jianle Chen, San Diego, CA (US); Kruthika Koratti Sivakumar, Sunnyvale, CA (US)

(21) Appl. No.: 19/541,093

(22) Filed: Feb. 16, 2026

Related U.S. Application Data
(60) Provisional application No. 63/762,357, filed on Feb. 24, 2025.

(51) Int. Cl. H04N 19/105; H04N 19/46

(52) U.S. Cl. CPC H04N 19/105; H04N 19/46

(57) ABSTRACT

Decoding using compound warp inter-intra prediction includes obtaining reconstructed block data for a current block. Obtaining the reconstructed block data includes accessing, from an encoded bitstream, compound warp inter-intra mode data indicating that the current block is coded using compound warp inter-intra mode, accessing, from the encoded bitstream, intra prediction mode data indicating an intra prediction mode for the current block, generating intra prediction block data for the current block in accordance with the intra prediction mode data, generating warp inter prediction block data for the current block, obtaining predicted block data for the current block by combining the warp inter prediction block data and the intra prediction block data, obtaining decoded block data by decoding encoded block data accessed from the encoded bitstream, and including, in the reconstructed block data, a sum of the decoded block data and the predicted block data.

### CROSS-REFERENCE TO RELATED APPLICATION(S)

This application claims priority to and the benefit of U.S. Provisional Application Patent Ser. No. 63/762,357 filed Feb. 24, 2025, the entire disclosure of which is hereby incorporated by reference.

### BACKGROUND

Digital images and video can be used, for example, on the internet, for remote business meetings via video conferencing, high-definition video entertainment, video advertisements, or sharing of user-generated content. Due to the large amount of data involved in transferring and processing image and video data, high-performance compression may be advantageous for transmission and storage. Accordingly, it would be advantageous to provide high-resolution image and video transmitted over communications channels having limited bandwidth.

### SUMMARY

This application relates to encoding and decoding of image data, video stream data, or both for transmission, storage, or both. Disclosed herein are aspects of systems, methods, and apparatuses for encoding and decoding using compound warp inter-intra prediction.

Variations in these and other aspects will be described in additional detail hereafter.

An aspect is a method for encoding using compound warp inter-intra prediction. Encoding using compound warp inter-intra prediction includes generating an encoded bitstream by encoding a current block from a current frame from an input video and outputting the encoded bitstream. Encoding the current block comprises including, in the encoded bitstream, compound warp inter-intra mode data indicating that the current block is coded using compound warp inter-intra mode, generating intra prediction block data for the current block in accordance with intra prediction mode data, including, in the encoded bitstream, intra prediction mode data indicating the intra prediction mode for the current block, generating warp inter prediction block data for the current block, obtaining predicted block data for the current block by combining the warp inter prediction block data and the intra prediction block data, obtaining encoded block data by encoding a difference between the predicted block data and current block data for the current block, and including, in the encoded bitstream, the encoded block data.

An aspect is a non-transitory computer-readable storage medium storing an encoded bitstream comprising compound warp inter-intra mode data indicating that a current block of a current frame of a sequence of frames is coded using compound warp inter-intra mode, intra prediction mode data indicating an intra prediction mode for coding the current block, and mask mode data indicating a mask mode for coding the current block.

An aspect is a method for decoding using compound warp inter-intra prediction. Decoding using compound warp inter-intra prediction includes obtaining reconstructed block data for a current block of a current frame of a sequence of frames, including the reconstructed block data in reconstructed frame data for the current frame, and outputting the reconstructed frame data. Obtaining the reconstructed block data includes accessing, from an encoded bitstream, compound warp inter-intra mode data indicating that the current block is coded using compound warp inter-intra mode, accessing, from the encoded bitstream, intra prediction mode data indicating an intra prediction mode for the current block, generating intra prediction block data for the current block in accordance with the intra prediction mode data, generating warp inter prediction block data for the current block, obtaining predicted block data for the current block by combining the warp inter prediction block data and the intra prediction block data, obtaining decoded block data by decoding encoded block data accessed from the encoded bitstream, and including, in the reconstructed block data, a sum of the decoded block data and the predicted block data.

### BRIEF DESCRIPTION OF THE DRAWINGS

The description herein makes reference to the accompanying drawings wherein like reference numerals refer to like parts throughout the several views unless otherwise noted or otherwise clear from context.

FIG. 1 is a diagram of a computing device in accordance with implementations of this disclosure.

FIG. 2 is a diagram of a computing and communications system in accordance with implementations of this disclosure.

FIG. 3 is a diagram of a video stream for use in encoding and decoding in accordance with implementations of this disclosure.

FIG. 4 is a block diagram of an encoder in accordance with implementations of this disclosure.

FIG. 5 is a block diagram of a decoder in accordance with implementations of this disclosure.

FIG. 6 is a block diagram of a representation of a portion of a frame in accordance with implementations of this disclosure.

FIG. 7 is a flowchart diagram of an example of encoding using compound warp inter-intra prediction in accordance with implementations of this disclosure.

FIG. 8 is a block diagram of an example of warp mode.

FIG. 9 is a block diagram of an example of obtaining compound warp inter-intra prediction block data using uniform mask mode.

FIG. 10 is a block diagram of an example of obtaining compound warp inter-intra prediction block data using wedge mask mode.

FIG. 11 is a flowchart diagram of an example of decoding using compound warp inter-intra prediction in accordance with implementations of this disclosure.

### DETAILED DESCRIPTION

Image and video compression schemes may include breaking an image, or frame, into smaller portions, such as blocks, and generating an output bitstream using techniques to minimize the bandwidth utilization of the information included for each block in the output. In some implementations, the information included for each block in the output may be limited by reducing spatial redundancy, reducing temporal redundancy, or a combination thereof. For example, temporal or spatial redundancies may be reduced by predicting a frame, or a portion thereof, based on information available to both the encoder and decoder, and including information representing a difference, or residual, between the predicted frame and the original frame in the encoded bitstream. The residual information may be further compressed by transforming the residual information into transform coefficients (e.g., energy compaction), quantizing the transform coefficients, and entropy coding the quantized transform coefficients. Other coding information, such as motion information, may be included in the encoded bitstream, which may include transmitting differential information based on predictions of the encoding information, which may be entropy coded to further reduce the corresponding bandwidth utilization. An encoded bitstream can be decoded to reconstruct the blocks and the source images from the limited information. In some implementations, the accuracy, efficiency, or both, of coding a block using either inter-prediction or intra-prediction may be limited.

Block-based hybrid video coding techniques, or codecs, to improve coding efficiency, predict a block of a frame either from one or more previously decoded, or reconstructed, frames (inter prediction) or from the current frame (intra prediction). In inter prediction, a motion compensated prediction is obtained where a motion vector (MV) of a respective predicted block is generated. To decode an inter-predicted block, a decoder obtains, such as generates, a dynamic reference list (DRL), which is a list of reference motion vectors, and which is generated from the previously decoded neighboring blocks in the current frame and collocated blocks of the reference frame. The dynamic reference list includes a list of reference motion vectors of a prediction block.

To improve the signaling of the motion vector, directly signaling the motion vector is omitted and a difference between the reference motion vector (ref mv) and the motion vector used to obtain the predicted block is signaled (differential motion vector). To indicate the candidate reference motion vector from the dynamic reference list to use as the reference motion vector, an index value in the dynamic reference list corresponding to the candidate reference motion vector is signaled. In some inter prediction modes, the reference motion vector is used as the motion vector for coding the current block. In some inter prediction modes, the differential motion vector is signaled and a combination, or summation, of the differential motion vector and the reference motion vector is used as the motion vector for coding the current block.

Some block-based hybrid video coding techniques, or codecs, may be limited to reducing temporal redundancy using a translational motion model, which may inefficiently or inaccurately represent non-translational motion. Some block-based hybrid video coding techniques, or codecs, may include warped motion video coding, including warped motion compensation, which may improve the efficiency, accuracy, or both, relative to block-based hybrid video coding techniques that are limited to reducing temporal redundancy using a translational motion model, with respect to non-translational motion. For example, some block-based hybrid video coding techniques may include warped motion video coding using a global warp motion model, a local warp motion model, or both.

Some block-based hybrid video coding techniques, or codecs, may include intra prediction coding one or more frames or blocks. Some block-based hybrid video coding techniques, or codecs, may include inter prediction coding one or more frames or blocks using uni-prediction inter coding with a, such as one, reference frame. Some block-based hybrid video coding techniques, or codecs, may include inter prediction coding one or more frames or blocks using compound inter-inter prediction (compound prediction) with a first reference frame and a second reference frame.

Some block-based hybrid video coding techniques, or codecs, may include compound (translational) inter-intra prediction coding one or more frames or blocks, which includes combining a translational inter prediction and an intra prediction, wherein warp inter prediction is omitted, skipped, avoided, or excluded. The exclusion of warp inter prediction modes in compound inter-intra prediction may limit accuracy, efficiency, or both.

The encoding and decoding using compound warp inter-intra prediction described herein improves on video coding techniques, or codecs, by coding one or more blocks, or frames, by combining a warp inter prediction with an intra prediction.

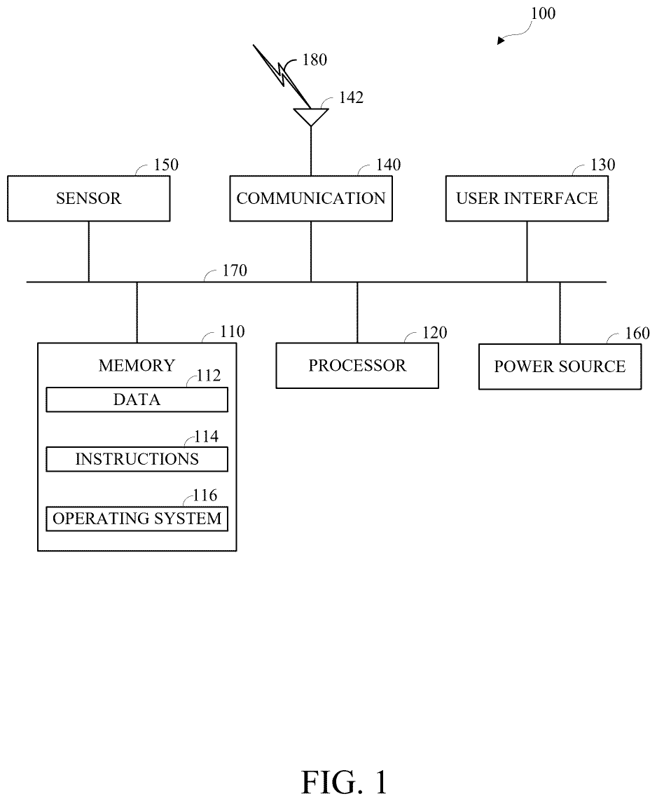

FIG. 1 is a diagram of a computing device 100 in accordance with implementations of this disclosure. The computing device 100 shown includes a memory 110, a processor 120, a user interface (UI) 130, an electronic communication unit 140, a sensor 150, a power source 160, and a bus 170. As used herein, the term “computing device” includes any unit, or a combination of units, capable of performing any method, or any portion or portions thereof, disclosed herein.

The computing device 100 may be a stationary computing device, such as a personal computer (PC), a server, a workstation, a minicomputer, or a mainframe computer; or a mobile computing device, such as a mobile telephone, a personal digital assistant (PDA), a laptop, or a tablet PC. Although shown as a single unit, any one element or elements of the computing device 100 can be integrated into any number of separate physical units. For example, the user interface 130 and processor 120 can be integrated in a first physical unit and the memory 110 can be integrated in a second physical unit.

The memory 110 can include any non-transitory computer-usable or computer-readable medium, such as any tangible device that can, for example, contain, store, communicate, or transport data 112, instructions 114, an operating system 116, or any information associated therewith, for use by or in connection with other components of the computing device 100. The non-transitory computer-usable or computer-readable medium can be, for example, a solid-state drive, a memory card, removable media, a read-only memory (ROM), a random-access memory (RAM), any type of disk including a hard disk, a floppy disk, an optical disk, a magnetic or optical card, application-specific integrated circuits (ASICs), or any type of non-transitory media suitable for storing electronic information, or any combination thereof.

Although shown as a single unit, the memory 110 may include multiple physical units, such as one or more primary memory units, such as random-access memory units, one or more secondary data storage units, such as disks, or a combination thereof. For example, the data 112, or a portion thereof, the instructions 114, or a portion thereof, or both, may be stored in a secondary storage unit and may be loaded or otherwise transferred to a primary storage unit in conjunction with processing the respective data 112, executing the respective instructions 114, or both. In some implementations, the memory 110, or a portion thereof, may be removable memory.

The data 112 can include information, such as input audio data, encoded audio data, decoded audio data, or the like. The instructions 114 can include directions, such as code, for performing any method, or any portion or portions thereof, disclosed herein. The instructions 114 can be realized in hardware, software, or any combination thereof. For example, the instructions 114 may be implemented as information stored in the memory 110, such as a computer program, which may be executed by the processor 120 to perform any of the respective methods, algorithms, aspects, or combinations thereof, as described herein.

Although shown as included in the memory 110, in some implementations, the instructions 114, or a portion thereof, may be implemented as a special purpose processor, or circuitry, that can include specialized hardware for carrying out any of the methods, algorithms, aspects, or combinations thereof, as described herein. Portions of the instructions 114 can be distributed across multiple processors on the same machine or different machines or across a network such as a local area network, a wide area network, the Internet, or a combination thereof.

The processor 120 can include any device or system capable of manipulating or processing a digital signal or other electronic information now-existing or hereafter developed, including optical processors, quantum processors, molecular processors, or a combination thereof. For example, the processor 120 can include a special purpose processor, a central processing unit (CPU), a digital signal processor (DSP), a plurality of microprocessors, one or more microprocessors in association with a DSP core, a controller, a microcontroller, an Application Specific Integrated Circuit (ASIC), a Field Programmable Gate Array (FPGA), a programmable logic array, programmable logic controller, microcode, firmware, any type of integrated circuit (IC), a state machine, or any combination thereof. As used herein, the term “processor” includes a single processor or multiple processors.

The user interface 130 can include any unit capable of interfacing with a user, such as a virtual or physical keypad, a touchpad, a display, a touch display, a speaker, a microphone, a video camera, a sensor, or any combination thereof. For example, the user interface 130 may be an audio-visual display device, and the computing device 100 may present audio, such as decoded audio, using the user interface 130 audio-visual display device, such as in conjunction with displaying video, such as decoded video. Although shown as a single unit, the user interface 130 may include one or more physical units. For example, the user interface 130 may include an audio interface for performing audio communication with a user, and a touch display for performing visual and touch-based communication with the user.

The electronic communication unit 140 can transmit, receive, or transmit and receive signals via a wired or wireless electronic communication medium 180, such as a radio frequency (RF) communication medium, an ultraviolet (UV) communication medium, a visible light communication medium, a fiber optic communication medium, a wireline communication medium, or a combination thereof. For example, as shown, the electronic communication unit 140 is operatively connected to an electronic communication interface 142, such as an antenna, configured to communicate via wireless signals.

Although the electronic communication interface 142 is shown as a wireless antenna in FIG. 1, the electronic communication interface 142 can be a wireless antenna, as shown, a wired communication port, such as an Ethernet port, an infrared port, a serial port, or any other wired or wireless unit capable of interfacing with a wired or wireless electronic communication medium 180. Although FIG. 1 shows a single electronic communication unit 140 and a single electronic communication interface 142, any number of electronic communication units and any number of electronic communication interfaces can be used.

The sensor 150 may include, for example, an audio-sensing device, a visible light-sensing device, a motion sensing device, or a combination thereof. For example, the sensor 150 may include a sound-sensing device, such as a microphone, or any other sound-sensing device now existing or hereafter developed that can sense sounds in the proximity of the computing device 100, such as speech or other utterances, made by a user operating the computing device 100. In another example, the sensor 150 may include a camera, or any other image-sensing device now existing or hereafter developed that can sense an image such as the image of a user operating the computing device. Although a single sensor 150 is shown, the computing device 100 may include a number of sensors 150. For example, the computing device 100 may include a first camera oriented with a field of view directed toward a user of the computing device 100 and a second camera oriented with a field of view directed away from the user of the computing device 100.

The power source 160 can be any suitable device for powering the computing device 100. For example, the power source 160 can include a wired external power source interface; one or more dry cell batteries, such as nickel-cadmium (NiCd), nickel-zinc (NiZn), nickel metal hydride (NiMH), lithium-ion (Li-ion); solar cells; fuel cells; or any other device capable of powering the computing device 100. Although a single power source 160 is shown in FIG. 1, the computing device 100 may include multiple power sources 160, such as a battery and a wired external power source interface.

Although shown as separate units, the electronic communication unit 140, the electronic communication interface 142, the user interface 130, the power source 160, or portions thereof, may be configured as a combined unit. For example, the electronic communication unit 140, the electronic communication interface 142, the user interface 130, and the power source 160 may be implemented as a communications port capable of interfacing with an external display device, providing communications, power, or both.

One or more of the memory 110, the processor 120, the user interface 130, the electronic communication unit 140, the sensor 150, or the power source 160, may be operatively coupled via a bus 170. Although a single bus 170 is shown in FIG. 1, a computing device 100 may include multiple buses. For example, the memory 110, the processor 120, the user interface 130, the electronic communication unit 140, the sensor 150, and the bus 170 may receive power from the power source 160 via the bus 170. In another example, the memory 110, the processor 120, the user interface 130, the electronic communication unit 140, the sensor 150, the power source 160, or a combination thereof, may communicate data, such as by sending and receiving electronic signals, via the bus 170.

Although not shown separately in FIG. 1, one or more of the processor 120, the user interface 130, the electronic communication unit 140, the sensor 150, or the power source 160 may include internal memory, such as an internal buffer or register. For example, the processor 120 may include internal memory (not shown) and may read data 112 from the memory 110 into the internal memory (not shown) for processing.

Although shown as separate elements, the memory 110, the processor 120, the user interface 130, the electronic communication unit 140, the sensor 150, the power source 160, and the bus 170, or any combination thereof can be integrated in one or more electronic units, circuits, or chips.

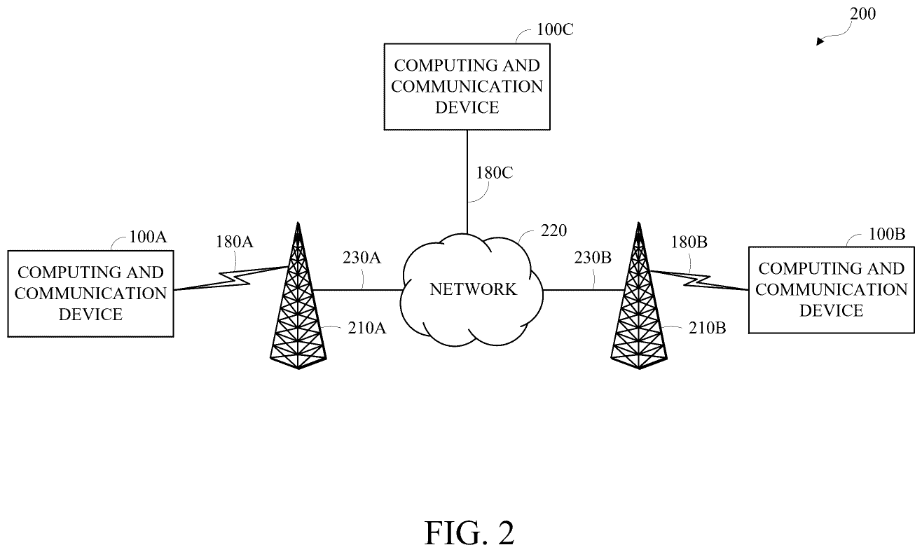

FIG. 2 is a diagram of a computing and communications system 200 in accordance with implementations of this disclosure. The computing and communications system 200 shown includes computing and communication devices 100A, 100B, 100C, access points 210A, 210B, and a network 220. For example, the computing and communication system 200 can be a multiple access system that provides communication, such as voice, audio, data, video, messaging, broadcast, or a combination thereof, to one or more wired or wireless communicating devices, such as the computing and communication devices 100A, 100B, 100C. Although, for simplicity, FIG. 2 shows three computing and communication devices 100A, 100B, 100C, two access points 210A, 210B, and one network 220, any number of computing and communication devices, access points, and networks can be used.

A computing and communication device 100A, 100B, 100C can be, for example, a computing device, such as the computing device 100 shown in FIG. 1. For example, the computing and communication devices 100A, 100B may be user devices, such as a mobile computing device, a laptop, a thin client, or a smartphone, and the computing and communication device 100C may be a server, such as a mainframe or a cluster. Although the computing and communication device 100A and the computing and communication device 100B are described as user devices, and the computing and communication device 100C is described as a server, any computing and communication device may perform some or all of the functions of a server, some, or all, of the functions of a user device, or some or all of the functions of a server and a user device. For example, the server computing and communication device 100C may receive, encode, process, store, transmit, or a combination thereof audio data and one or both of the computing and communication device 100A and the computing and communication device 100B may receive, decode, process, store, present, or a combination thereof the audio data.

Each computing and communication device 100A, 100B, 100C, which may include a user equipment (UE), a mobile station, a fixed or mobile subscriber unit, a cellular telephone, a personal computer, a tablet computer, a server, consumer electronics, or any similar device, can be configured to perform wired or wireless communication, such as via the network 220. For example, the computing and communication devices 100A, 100B, 100C can be configured to transmit or receive wired or wireless communication signals. Although each computing and communication device 100A, 100B, 100C is shown as a single unit, a computing and communication device can include any number of interconnected elements.

Each access point 210A, 210B can be any type of device configured to communicate with a computing and communication device 100A, 100B, 100C, a network 220, or both via wired or wireless communication links 180A, 180B, 180C. For example, an access point 210A, 210B can include a base station, a base transceiver station (BTS), a Node-B, an enhanced Node-B (eNode-B), a Home Node-B (HNode-B), a wireless router, a wired router, a hub, a relay, a switch, or any similar wired or wireless device. Although each access point 210A, 210B is shown as a single unit, an access point can include any number of interconnected elements.

The network 220 can be any type of network configured to provide services, such as voice, data, applications, voice over internet protocol (VoIP), or any other communications protocol or combination of communications protocols, over a wired or wireless communication link. For example, the network 220 can be a local area network (LAN), wide area network (WAN), virtual private network (VPN), a mobile or cellular telephone network, the Internet, or any other means of electronic communication. The network can use a communication protocol, such as the transmission control protocol (TCP), the user datagram protocol (UDP), the internet protocol (IP), the real-time transport protocol (RTP) the HyperText Transport Protocol (HTTP), or a combination thereof.

The computing and communication devices 100A, 100B, 100C can communicate with each other via the network 220 using one or more wired or wireless communication links, or via a combination of wired and wireless communication links. For example, as shown the computing and communication devices 100A, 100B can communicate via wireless communication links 180A, 180B, and computing and communication device 100C can communicate via a wired communication link 180C. Any of the computing and communication devices 100A, 100B, 100C may communicate using any wired or wireless communication link, or links. For example, a first computing and communication device 100A can communicate via a first access point 210A using a first type of communication link, a second computing and communication device 100B can communicate via a second access point 210B using a second type of communication link, and a third computing and communication device 100C can communicate via a third access point (not shown) using a third type of communication link. Similarly, the access points 210A, 210B can communicate with the network 220 via one or more types of wired or wireless communication links 230A, 230B. Although FIG. 2 shows the computing and communication devices 100A, 100B, 100C in communication via the network 220, the computing and communication devices 100A, 100B, 100C can communicate with each other via any number of communication links, such as a direct wired or wireless communication link.

In some implementations, communications between one or more of the computing and communication device 100A, 100B, 100C may omit communicating via the network 220 and may include transferring data via another medium (not shown), such as a data storage device. For example, the server computing and communication device 100C may store audio data, such as encoded audio data, in a data storage device, such as a portable data storage unit, and one or both of the computing and communication device 100A or the computing and communication device 100B may access, read, or retrieve the stored audio data from the data storage unit, such as by physically disconnecting the data storage device from the server computing and communication device 100C and physically connecting the data storage device to the computing and communication device 100A or the computing and communication device 100B.

Other implementations of the computing and communications system 200 are possible. For example, in an implementation, the network 220 can be an ad-hoc network and can omit one or more of the access points 210A, 210B. The computing and communications system 200 may include devices, units, or elements not shown in FIG. 2. For example, the computing and communications system 200 may include many more communicating devices, networks, and access points.

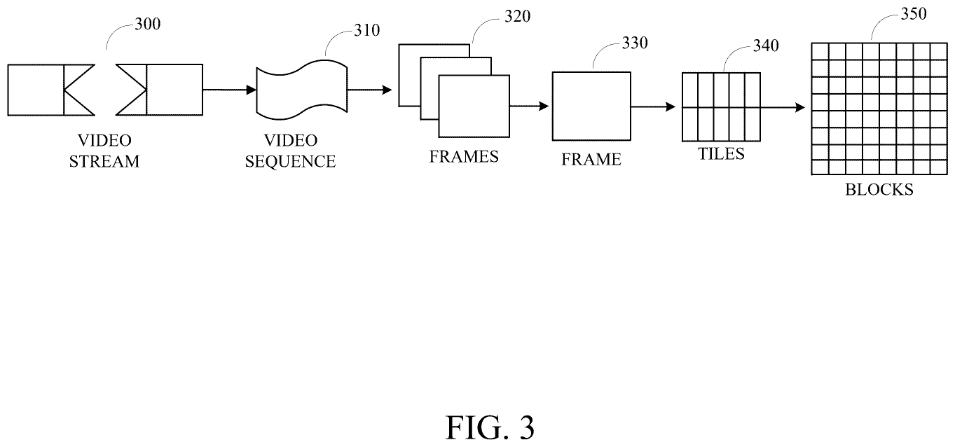

FIG. 3 is a diagram of a video stream 300 for use in encoding and decoding in accordance with implementations of this disclosure. A video stream 300, such as a video stream captured by a video camera or a video stream generated by a computing device, may include a video sequence 310. The video sequence 310 may include a sequence of adjacent frames 320. Although three adjacent frames 320 are shown, the video sequence 310 can include any number of adjacent frames 320.

Each frame 330 from the adjacent frames 320 may represent a single image from the video stream. Although not shown in FIG. 3, a frame 330 may include one or more segments, tiles, or planes, which may be coded, or otherwise processed, independently, such as in parallel. A frame 330 may include one or more tiles 340. Each of the tiles 340 may be a rectangular region of the frame that can be coded independently. Each of the tiles 340 may include respective blocks 350. Although not shown in FIG. 3, a block can include pixels. For example, a block can include a 16×16 group of pixels, an 8×8 group of pixels, an 8×16 group of pixels, or any other group of pixels. Unless otherwise indicated herein, the term ‘block’ can include a superblock, a macroblock, a segment, a slice, or any other portion of a frame. A frame, a block, a pixel, or a combination thereof can include display information, such as luminance information, chrominance information, or any other information that can be used to store, modify, communicate, or display the video stream or a portion thereof.

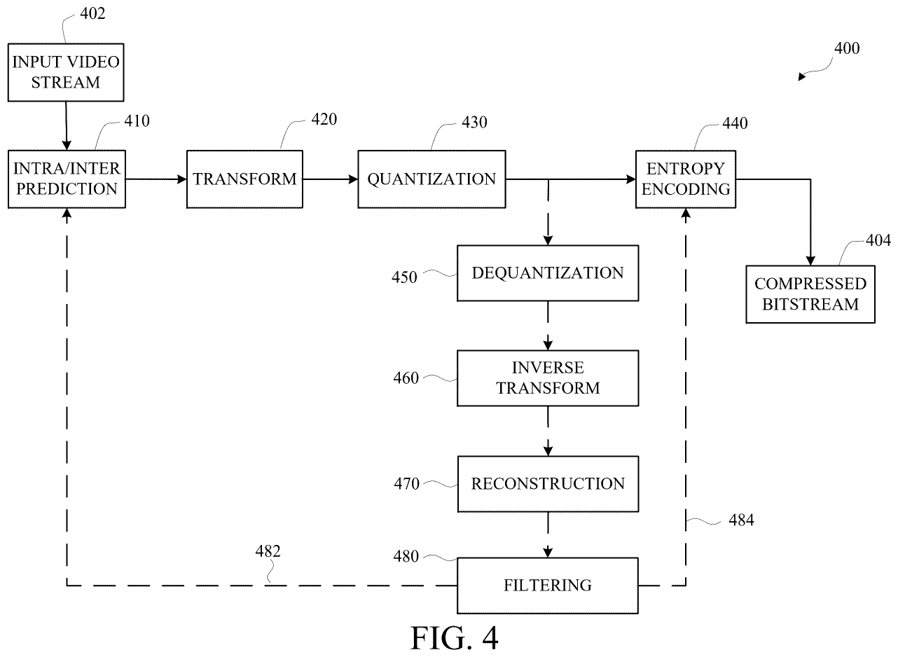

FIG. 4 is a block diagram of an encoder 400 in accordance with implementations of this disclosure. Encoder 400 can be implemented in a device, such as the computing device 100 shown in FIG. 1 or the computing and communication devices 100A, 100B, 100C shown in FIG. 2, as, for example, a computer software program stored in a data storage unit, such as the memory 110 shown in FIG. 1. The computer software program can include machine instructions that may be executed by a processor, such as the processor 120 shown in FIG. 1, and may cause the device to encode video data as described herein. The encoder 400 can be implemented as specialized hardware included, for example, in computing device 100.

The encoder 400 can encode an input video stream 402, such as the video stream 300 shown in FIG. 3, to generate an encoded (compressed) bitstream 404. In some implementations, the encoder 400 may include a forward path for generating the compressed bitstream 404. The forward path may include an intra/inter prediction unit 410, a transform unit 420, a quantization unit 430, an entropy encoding unit 440, or any combination thereof. In some implementations, the encoder 400 may include a reconstruction path (indicated by the broken connection lines) to reconstruct a frame for encoding of further blocks. The reconstruction path may include a dequantization unit 450, an inverse transform unit 460, a reconstruction unit 470, a filtering unit 480, or any combination thereof. Other structural variations of the encoder 400 can be used to encode the video stream 402.

For encoding the video stream 402, each frame within the video stream 402 can be processed in units of blocks. Thus, a current block may be identified from the blocks in a frame, and the current block may be encoded.

At the intra/inter prediction unit 410, the current block can be encoded using either intra-frame prediction, which may be within a single frame, or inter-frame prediction, which may be from frame to frame. Intra-prediction may include generating a prediction block from samples in the current frame that have been previously encoded and reconstructed. Inter-prediction may include generating a prediction block from samples in one or more previously constructed reference frames. Generating a prediction block for a current block in a current frame may include performing motion estimation to generate a motion vector indicating an appropriate reference portion of the reference frame.

The intra/inter prediction unit 410 may subtract the prediction block from the current block (raw block) to produce a residual block. The transform unit 420 may perform a block-based transform, which may include transforming the residual block into transform coefficients in, for example, the frequency domain. Examples of block-based transforms include the Karhunen-Loeve Transform (KLT), the Discrete Cosine Transform (DCT), the Singular Value Decomposition Transform (SVD), and the Asymmetric Discrete Sine Transform (ADST). In an example, the DCT may include transforming a block into the frequency domain. The DCT may include using transform coefficient values based on spatial frequency, with the lowest frequency (i.e., direct current (DC)) coefficient at the top-left of the matrix and the highest frequency coefficient at the bottom-right of the matrix.

The quantization unit 430 may convert the transform coefficients into discrete quantum values, which may be referred to as quantized transform coefficients or quantization levels. The quantized transform coefficients can be entropy encoded by the entropy encoding unit 440 to produce entropy-encoded coefficients. Entropy encoding can include using a probability distribution metric. The entropy-encoded coefficients and information used to decode the block, which may include the type of prediction used, motion vectors, and quantizer values, can be output to the compressed bitstream 404. The compressed bitstream 404 can be formatted using various techniques, such as run-length encoding (RLE) and zero-run coding.

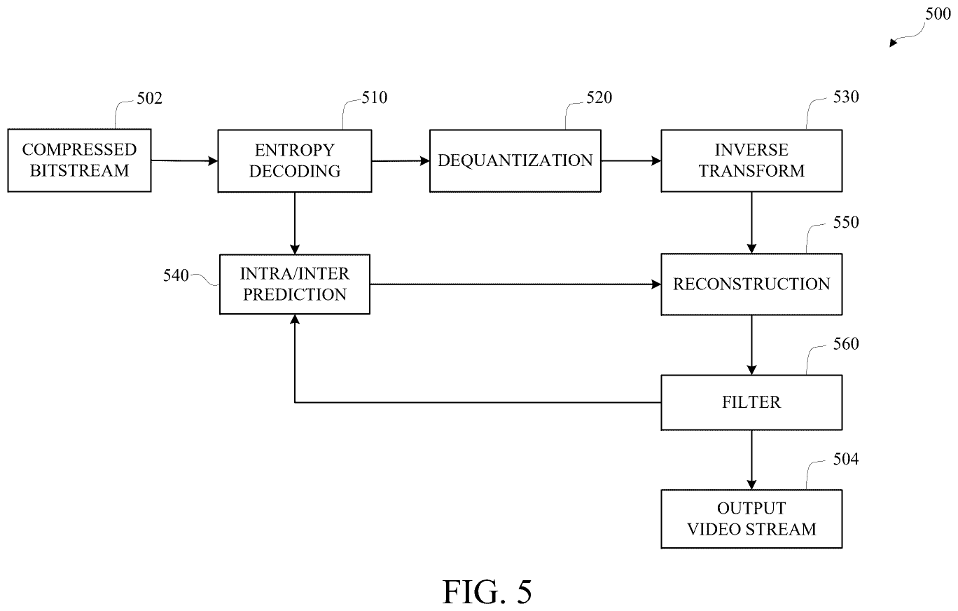

The reconstruction path can be used to maintain reference frame synchronization between the encoder 400 and a corresponding decoder, such as the decoder 500 shown in FIG. 5. The reconstruction path may be similar to the decoding process discussed below and may include decoding the encoded frame, or a portion thereof, which may include decoding an encoded block, which may include dequantizing the quantized transform coefficients at the dequantization unit 450 and inverse transforming the dequantized transform coefficients at the inverse transform unit 460 to produce a derivative residual block. The reconstruction unit 470 may add the prediction block generated by the intra/inter prediction unit 410 to the derivative residual block to create a decoded block. The filtering unit 480 can be applied to the decoded block to generate a reconstructed block, which may reduce distortion, such as blocking artifacts. Although one filtering unit 480 is shown in FIG. 4, filtering the decoded block may include loop filtering, deblocking filtering, or other types of filtering or combinations of types of filtering. The reconstructed block may be stored or otherwise made accessible as a reconstructed block, which may be a portion of a reference frame, for encoding another portion of the current frame, another frame, or both, as indicated by the broken line at 482. Coding information, such as deblocking threshold index values, for the frame may be encoded, included in the compressed bitstream 404, or both, as indicated by the broken line at 484.

Other variations of the encoder 400 can be used to encode the compressed bitstream 404. For example, a non-transform-based encoder 400 can quantize the residual block directly without the transform unit 420. In some implementations, the quantization unit 430 and the dequantization unit 450 may be combined into a single unit.

FIG. 5 is a block diagram of a decoder 500 in accordance with implementations of this disclosure. The decoder 500 can be implemented in a device, such as the computing device 100 shown in FIG. 1 or the computing and communication devices 100A, 100B, 100C shown in FIG. 2, as, for example, a computer software program stored in a data storage unit, such as the memory 110 shown in FIG. 1. The computer software program can include machine instructions that may be executed by a processor, such as the processor 120 shown in FIG. 1, and may cause the device to decode video data as described herein. The decoder 500 can be implemented as specialized hardware included, for example, in computing device 100.

The decoder 500 may receive a compressed bitstream 502, such as the compressed bitstream 404 shown in FIG. 4, and may decode the compressed bitstream 502 to generate an output video stream 504. The decoder 500 may include an entropy decoding unit 510, a dequantization unit 520, an inverse transform unit 530, an intra/inter prediction unit 540, a reconstruction unit 550, a filtering unit 560, or any combination thereof. Other structural variations of the decoder 500 can be used to decode the compressed bitstream 502.

The entropy decoding unit 510 may decode data elements within the compressed bitstream 502 using, for example, Context Adaptive Binary Arithmetic Decoding, to produce a set of quantized transform coefficients. The dequantization unit 520 can dequantize the quantized transform coefficients, and the inverse transform unit 530 can inverse transform the dequantized transform coefficients to produce a derivative residual block, which may correspond to the derivative residual block generated by the inverse transform unit 460 shown in FIG. 4. Using header information decoded from the compressed bitstream 502, the intra/inter prediction unit 540 may generate a prediction block corresponding to the prediction block created in the encoder 400. At the reconstruction unit 550, the prediction block can be added to the derivative residual block to create a decoded block. The filtering unit 560 can be applied to the decoded block to reduce artifacts, such as blocking artifacts, which may include loop filtering, deblocking filtering, or other types of filtering or combinations of types of filtering, and which may include generating a reconstructed block, which may be output as the output video stream 504.

Other variations of the decoder 500 can be used to decode the compressed bitstream 502. For example, the decoder 500 can produce the output video stream 504 without the deblocking filtering unit 560.

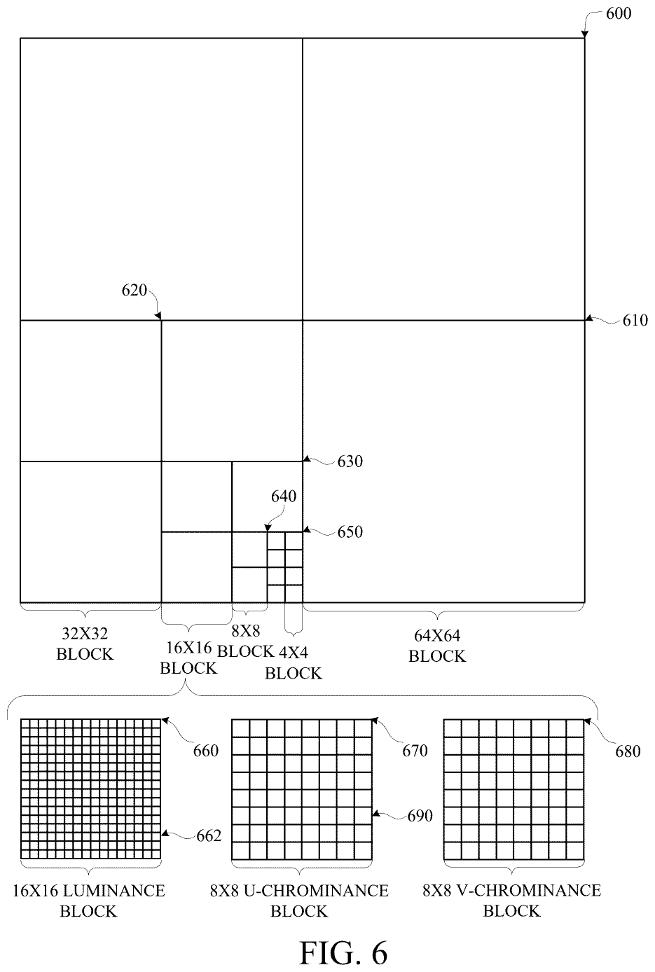

FIG. 6 is a block diagram of a representation of a portion 600 of a frame, such as the frame 330 shown in FIG. 3, in accordance with implementations of this disclosure. As shown, the portion 600 of the frame includes four 64×64 blocks 610, in two rows and two columns in a matrix or Cartesian plane. In some implementations, a 64×64 block may be a maximum coding unit, N=64. Each 64×64 block may include four 32×32 blocks 620. Each 32×32 block may include four 16×16 blocks 630. Each 16×16 block may include four 8×8 blocks 640. Each 8×8 block 640 may include four 4×4 blocks 650. Each 4×4 block 650 may include 16 pixels, which may be represented in four rows and four columns in each respective block in the Cartesian plane or matrix. The pixels may include information representing an image captured in the frame, such as luminance information, color information, and location information. In some implementations, a block, such as a 16×16 pixel block as shown, may include a luminance block 660, which may include luminance pixels 662; and two chrominance blocks 670, 680, such as a U or Cb chrominance block 670, and a V or Cr chrominance block 680. The chrominance blocks 670, 680 may include chrominance pixels 690. For example, the luminance block 660 may include 16×16 luminance pixels 662 and each chrominance block 670, 680 may include 8×8 chrominance pixels 690 as shown. Although one arrangement of blocks is shown, any arrangement may be used. Although FIG. 6 shows N×N blocks, in some implementations, N×M blocks may be used. For example, 32×64 blocks, 64×32 blocks, 16×32 blocks, 32×16 blocks, or any other size blocks may be used. In some implementations, N×2N blocks, 2N×N blocks, or a combination thereof may be used.

In some implementations, video coding may include ordered block-level coding. Ordered block-level coding may include coding blocks of a frame in an order, such as raster-scan order, wherein blocks may be identified and processed starting with a block in the upper left corner of the frame, or portion of the frame, and proceeding along rows from left to right and from the top row to the bottom row, identifying each block in turn for processing. For example, the 64×64 block in the top row and left column of a frame may be the first block coded and the 64×64 block immediately to the right of the first block may be the second block coded. The second row from the top may be the second row coded, such that the 64×64 block in the left column of the second row may be coded after the 64×64 block in the rightmost column of the first row.

In some implementations, coding a block may include using quad-tree coding, which may include coding smaller block units within a block in raster-scan order. For example, the 64×64 block shown in the bottom left corner of the portion of the frame shown in FIG. 6, may be coded using quad-tree coding wherein the top left 32×32 block may be coded, then the top right 32×32 block may be coded, then the bottom left 32×32 block may be coded, and then the bottom right 32×32 block may be coded. Each 32×32 block may be coded using quad-tree coding wherein the top left 16×16 block may be coded, then the top right 16×16 block may be coded, then the bottom left 16×16 block may be coded, and then the bottom right 16×16 block may be coded. Each 16×16 block may be coded using quad-tree coding wherein the top left 8×8 block may be coded, then the top right 8×8 block may be coded, then the bottom left 8×8 block may be coded, and then the bottom right 8×8 block may be coded. Each 8×8 block may be coded using quad-tree coding wherein the top left 4×4 block may be coded, then the top right 4×4 block may be coded, then the bottom left 4×4 block may be coded, and then the bottom right 4×4 block may be coded. In some implementations, 8×8 blocks may be omitted for a 16×16 block, and the 16×16 block may be coded using quad-tree coding wherein the top left 4×4 block may be coded, then the other 4×4 blocks in the 16×16 block may be coded in raster-scan order.

In some implementations, video coding may include compressing the information included in an original, or input, frame by, for example, omitting some of the information in the original frame from a corresponding encoded frame. For example, coding may include reducing spectral redundancy, reducing spatial redundancy, reducing temporal redundancy, or a combination thereof.

In some implementations, reducing spectral redundancy may include using a color model based on a luminance component (Y) and two chrominance components (U and V or Cb and Cr), which may be referred to as the YUV or YCbCr color model, or color space. Using the YUV color model may include using a relatively large amount of information to represent the luminance component of a portion of a frame and using a relatively small amount of information to represent each corresponding chrominance component for the portion of the frame. For example, a portion of a frame may be represented by a high-resolution luminance component, which may include a 16×16 block of pixels, and by two lower resolution chrominance components, each of which represents the portion of the frame as an 8×8 block of pixels. A pixel may indicate a value, for example, a value in the range from 0 to 255, and may be stored or transmitted using, for example, eight bits. Although this disclosure is described in reference to the YUV color model, any color model may be used.

In some implementations, reducing spatial redundancy may include transforming a block into the frequency domain using, for example, a discrete cosine transform (DCT). For example, a unit of an encoder, such as the transform unit 420 shown in FIG. 4, may perform a DCT using transform coefficient values based on spatial frequency.

In some implementations, reducing temporal redundancy may include using similarities between frames to encode a frame using a relatively small amount of data based on one or more reference frames, which may be previously encoded, decoded, and reconstructed frames of the video stream. For example, a block or pixel of a current frame may be similar to a spatially corresponding block or pixel of a reference frame. In some implementations, a block or pixel of a current frame may be similar to block or pixel of a reference frame at a different spatial location and reducing temporal redundancy may include generating motion information indicating the spatial difference, or translation, between the location of the block or pixel in the current frame and corresponding location of the block or pixel in the reference frame.

In some implementations, reducing temporal redundancy may include identifying a portion of a reference frame that corresponds to a current block or pixel of a current frame. For example, a reference frame, or a portion of a reference frame, which may be stored in memory, may be searched to identify a portion for generating a prediction to use for encoding a current block or pixel of the current frame with maximal efficiency. For example, the search may identify a portion of the reference frame for which the difference in pixel values between the current block and a prediction block generated based on the portion of the reference frame is minimized and may be referred to as motion searching. In some implementations, the portion of the reference frame searched may be limited. For example, the portion of the reference frame searched, which may be referred to as the search area, may include a limited number of rows of the reference frame. In an example, identifying the portion of the reference frame for generating a prediction may include calculating a cost function, such as a sum of absolute differences (SAD), between the pixels of portions of the search area and the pixels of the current block.

In some implementations, the spatial difference between the location of the portion of the reference frame for generating a prediction in the reference frame and the current block in the current frame may be represented as a motion vector. The difference in pixel values between the prediction block and the current block may be referred to as differential data, residual data, a prediction error, or as a residual block. In some implementations, generating motion vectors may be referred to as motion estimation, and a pixel of a current block may be indicated based on location using Cartesian coordinates as f_{x, y}. Similarly, a pixel of the search area of the reference frame may be indicated based on location using Cartesian coordinates as r_{x, y}. A motion vector (MV) for the current block may be determined based on, for example, a SAD between the pixels of the current frame and the corresponding pixels of the reference frame.

Although described herein with reference to matrix or Cartesian representation of a frame for clarity, a frame may be stored, transmitted, processed, or any combination thereof, in any data structure such that pixel values may be efficiently represented for a frame or image. For example, a frame may be stored, transmitted, processed, or any combination thereof, in a two-dimensional data structure such as a matrix as shown, or in a one-dimensional data structure, such as a vector array. In an implementation, a representation of the frame, such as a two-dimensional representation as shown, may correspond to a physical location in a rendering of the frame as an image. For example, a location in the top left corner of a block in the top left corner of the frame may correspond with a physical location in the top left corner of a rendering of the frame as an image.

In some implementations, block-based coding efficiency may be improved by partitioning input blocks into one or more prediction partitions, which may be rectangular, including square, partitions for prediction coding. In some implementations, video coding using prediction partitioning may include selecting a prediction partitioning scheme from among multiple candidate prediction partitioning schemes. For example, in some implementations, candidate prediction partitioning schemes for a 64×64 coding unit may include rectangular size prediction partitions ranging in sizes from 4×4 to 64×64, such as 4×4, 4×8, 8×4, 8×8, 8×16, 16×8, 16×16, 16×32, 32×16, 32×32, 32×64, 64×32, or 64×64. In some implementations, video coding using prediction partitioning may include a full prediction partition search, which may include selecting a prediction partitioning scheme by encoding the coding unit using each available candidate prediction partitioning scheme and selecting the best scheme, such as the scheme that produces the least rate-distortion error.

In some implementations, encoding a video frame may include identifying a prediction partitioning scheme for encoding a current block, such as block 610. In some implementations, identifying a prediction partitioning scheme may include determining whether to encode the block as a single prediction partition of maximum coding unit size, which may be 64×64 as shown, or to partition the block into multiple prediction partitions, which may correspond with the sub-blocks, such as the 32×32 blocks 620 the 16×16 blocks 630, or the 8×8 blocks 640, as shown, and may include determining whether to partition into one or more smaller prediction partitions. For example, a 64×64 block may be partitioned into four 32×32 prediction partitions. Three of the four 32×32 prediction partitions may be encoded as 32×32 prediction partitions and the fourth 32×32 prediction partition may be further partitioned into four 16×16 prediction partitions. Three of the four 16×16 prediction partitions may be encoded as 16×16 prediction partitions and the fourth 16×16 prediction partition may be further partitioned into four 8×8 prediction partitions, each of which may be encoded as an 8×8 prediction partition. In some implementations, identifying the prediction partitioning scheme may include using a prediction partitioning decision tree.

In some implementations, video coding for a current block may include identifying an optimal prediction coding mode from multiple candidate prediction coding modes, which may provide flexibility in handling video signals with various statistical properties and may improve the compression efficiency. For example, a video coder may evaluate each candidate prediction coding mode to identify the optimal prediction coding mode, which may be, for example, the prediction coding mode that minimizes an error metric, such as a rate-distortion cost, for the current block. In some implementations, the complexity of searching the candidate prediction coding modes may be reduced by limiting the set of available candidate prediction coding modes based on similarities between the current block and a corresponding prediction block. In some implementations, the complexity of searching each candidate prediction coding mode may be reduced by performing a directed refinement mode search. For example, metrics may be generated for a limited set of candidate block sizes, such as 16×16, 8×8, and 4×4, the error metric associated with each block size may be in descending order, and additional candidate block sizes, such as 4×8 and 8×4 block sizes, may be evaluated.

In some implementations, block-based coding efficiency may be improved by partitioning a current residual block into one or more transform partitions, which may be rectangular, including square, partitions for transform coding. In some implementations, video coding, such as video coding using transform partitioning, may include selecting a uniform transform partitioning scheme. For example, a current residual block, such as block 610, may be a 64×64 block and may be transformed without partitioning using a 64×64 transform.

Although not expressly shown in FIG. 6, a residual block may be transform partitioned using a uniform transform partitioning scheme. For example, a 64×64 residual block may be transform partitioned using a uniform transform partitioning scheme including four 32×32 transform blocks, using a uniform transform partitioning scheme including sixteen 16×16 transform blocks, using a uniform transform partitioning scheme including sixty-four 8×8 transform blocks, or using a uniform transform partitioning scheme including 256 4×4 transform blocks.

In some implementations, video coding, such as video coding using transform partitioning, may include identifying multiple transform block sizes for a residual block using multiform transform partition coding. In some implementations, multiform transform partition coding may include recursively determining whether to transform a current block using a current block size transform or by partitioning the current block and multiform transform partition coding each partition. For example, the bottom left block 610 shown in FIG. 6 may be a 64×64 residual block, and multiform transform partition coding may include determining whether to code the current 64×64 residual block using a 64×64 transform or to code the 64×64 residual block by partitioning the 64×64 residual block into partitions, such as four 32×32 blocks 620, and multiform transform partition coding each partition. In some implementations, determining whether to transform partition the current block may be based on comparing a cost for encoding the current block using a current block size transform to a sum of costs for encoding each partition using partition size transforms.

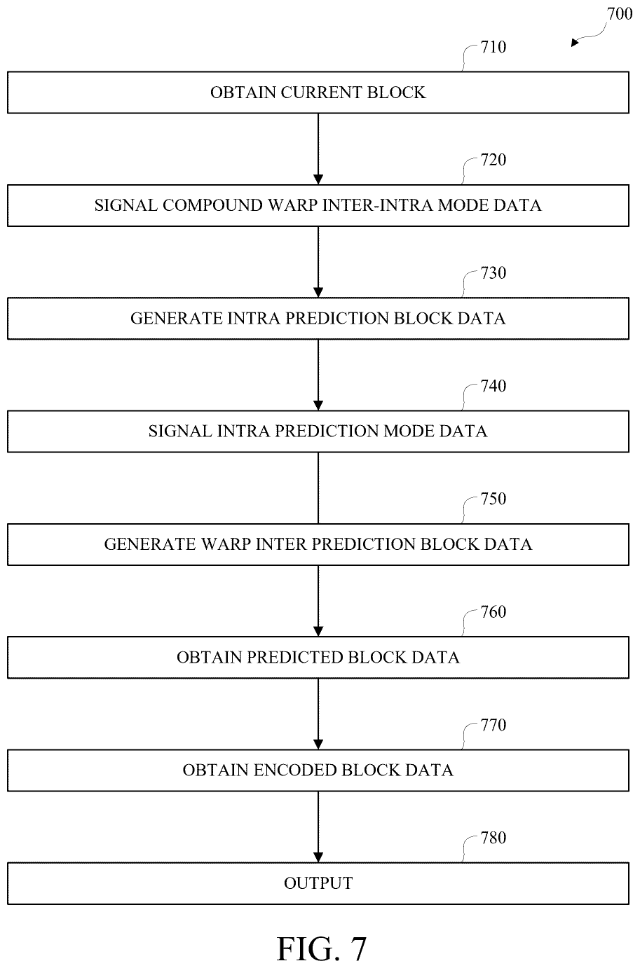

FIG. 7 is a flowchart diagram of an example of encoding using compound warp inter-intra prediction 700 in accordance with implementations of this disclosure. Encoding using compound warp inter-intra prediction 700 may be implemented in an encoder, such as the encoder 400 shown in FIG. 4, or one or more portions thereof.

Encoding using compound warp inter-intra prediction 700 includes generating an encoded bitstream by encoding a current block from a current frame from an input video stream, such as the input video stream 402 shown in FIG. 4, or one or more portions thereof, to generate an encoded (compressed) output bitstream, such as the encoded (compressed) bitstream 404 shown in FIG. 4, or one or more portions thereof. In block-based hybrid video coding, to reduce, or minimize, the resource utilization, such as bandwidth utilization, for signaling, storing, or both, compressed, or encoded, video data, redundant data, such as spatially redundant data, temporally redundant data, or both, is omitted or excluded from the compressed, or encoded, data. For example, spatial redundancy may be reduced using intra prediction, wherein the current block is predicted from the current frame. In another example, temporal redundancy may be reduced using inter prediction, wherein the current block is predicted from one or more reference frames, which may be previously decoded (and reconstructed) frames, constructed reference frames, or both.

Encoding using compound warp inter-intra prediction 700 includes generating an encoded bitstream by encoding the current block from the current frame from the input video.

The encoder maintains, such as stores in local memory, such as in a decoded frame buffer (or reference frame buffer, or reconstructed frame buffer), one or more reconstructed frames, which may be used as reference frames for inter prediction. The reconstructed reference frames may include one or more recently output, or displayed, reconstructed frames. The reconstructed reference frames may include one or more previously output, or displayed, reconstructed frames, output, or displayed, prior to outputting, or displaying, the recently output, or displayed, reconstructed frames, such as golden, or key, frames, which may be intra coded frames. The reconstructed reference frames may include one or more frames that are designated as output, or display (displayable) frames. The reconstructed reference frames may include one or more alternate, or constructed, reference frames, which may be non-displayed frames, and which may be synthesized, or constructed, by the encoder, such as using temporal filtering along the motion trajectories of multiple frames.

A reference frame in the reference frame buffer may be identified, or identifiable, using an index value (reference frame index value) with respect to the reference frame buffer wherein a location, or position, in the reference frame buffer is uniquely identifiable by a respective index value. To reduce, or minimize, the resource utilization, such as bandwidth utilization, for signaling, storing, or both, data identifying the reference frame, or reference frames, used for inter coding, the reference frame, or reference frames, may be expressed, represented, or communicated, by signaling the corresponding reference frame index value. In some implementations, the reference frame index value may be signaled differentially, wherein a difference between the reference frame index value for the current block and a reference frame index value obtained from a neighboring previously coded block is signaled.

Inter prediction includes motion estimation to obtain motion data in accordance with a motion model, such as a translational motion model or a warp motion model. Motion expressed in accordance with a translational motion model may include translational motion vectors that indicate a displacement between a location of a current block in the current frame and a location in the reference frame. In some implementations, motion vectors with respect to multiple reference frames, such as a forward reference frame and a backward reference frame, may be used.

To reduce, or minimize, the resource utilization, such as bandwidth utilization, for signaling, storing, or both, translational motion vectors, the translational motion vectors may be signaled differentially, wherein a difference between a respective translational motion vector for the current block and a reference motion vector (predicted motion vector or motion vector prediction) obtained from one or more context blocks. The context blocks are previously reconstructed blocks spatially neighboring the current block (corresponding to spatial motion vector predictions), or temporally collocated with the current block (corresponding to temporal motion vector predictions).

Spatial, translational, motion vector predictions can be identified from context blocks spatially neighboring the current block in the current frame, including adjacent spatial neighboring blocks, which are direct neighbors of the current block in the current frame, such as blocks above the current block, blocks to the left of the current block, a block above and to the left of the current block, a block above and to the right of the current block, or a combination thereof, and non-adjacent spatial neighboring blocks, such as blocks that are adjacent, such as within a defined distance, such as two rows or two columns, of blocks that are immediately adjacent to the current block. Temporal, translational, motion vector predictions can be identified from one or more collocated context blocks temporally neighboring the current block.

Motion, other than translational motion, which may be inaccurately represented using translational motion vectors, may be expressed in accordance with a warp motion model, such as a homographic warp motion model, an affine warp motion model, a similarity warp motion model, or another warp motion model, such as for warped motion compensation. As used herein, the terms “warp” and “warped” motion refers to non-translational motion, instead of or in addition to translational motion, such as affine motion, homographic motion, or similarity motion, in addition to, or instead of, translational motion. For example, in warped motion compensation, where a current pixel at position (x, y) of a current frame is projected to the position (x′, y′) of a reference frame.

In some implementations, six-parameter warped motion may be referred to as six-parameter affine motion, and a corresponding model may be referred to as a six-parameter affine motion model. In some implementations, a model corresponding to six-parameter warped motion may be referred to as a six-parameter warp motion model. In some implementations, four-parameter warped motion may be referred to as four-parameter affine motion, and a corresponding model may be referred to as a four-parameter affine motion model. In some implementations, a model corresponding to four-parameter warped motion may be referred to as a four-parameter warp motion model.

A homographic warp motion model includes eight parameters to indicate displacement between pixels of the current block and pixels of the reference frame, such as in a quadrilateral portion of the reference frame, for generating a prediction block. A homographic warp motion model may represent translation, rotation, scaling, changes in aspect ratio, shearing, and other non-parallelogram warping.

An affine warp motion model includes six-parameters to indicate displacement between pixels of the current block and pixels of the reference frame, such as in a parallelogram portion of the reference frame, for generating a prediction block. An affine warp motion model is a linear transformation between the coordinates of two spaces represented by the six-parameters. An affine warp motion model may represent translation, rotation, scale, changes in aspect ratio, and shearing. The parameters of the affine warp motion model include a first pair of parameters (h₁₃, h₂₃) that represent translational motion (translational parameters), such as a horizontal translational motion parameter (h₁₃) and a vertical translational motion parameter (h₂₃). The parameters of the affine warp motion model include a second pair of parameters (h₁₁, h₂₂) that represent scaling (scaling parameters), such as a horizontal scaling parameter (h₁₁) and a vertical scaling parameter (h₂₂). The parameters of the affine warp motion model include a third pair of parameters (h₁₂, h₂₁) that, in conjunction with the scaling parameters, represent angular rotation (rotation parameters), such as a first rotation parameter (h12) and a second rotation parameter (h21). For example, for a current pixel at position (x, y) from the current frame, a corresponding position (x′, y′) from the reference frame may be indicated using the affine warp motion model, which may include a horizontal displacement (x′) for encoding the current block that is a result of adding a result of multiplying the horizontal scaling parameter by the current horizontal position, a result of multiplying the first rotation parameter by the current vertical position, and the horizontal translational motion parameter, and a vertical displacement (y′) for encoding the current block that is a result of adding a result of multiplying the vertical scaling parameter by the current horizontal position, a result of multiplying the second rotation parameter by the current vertical position, and the vertical translational motion parameter, which may be expressed as the following:

$${x}^{′} = {h}_{11} x + {h}_{12} y + {h}_{13} , \qquad [ Equation 1 ]$$

$${y}^{′} = {h}_{21} x + {h}_{22} y + {h}_{23} . \qquad [ Equation 2 ]$$

A similarity warp motion model includes four-parameters to indicate displacement between pixels of the current block and pixels of the reference frame, such as in a square portion of the reference frame, for generating a prediction block. A similarity warp motion model is a linear transformation between the coordinates of two spaces represented by the four-parameters. For example, the four-parameters can be a translation along the x-axis, a translation along the y-axis, a rotation value, and a zoom value. A similarity warp motion model may represent square-to-square transformation with rotation and zoom. The parameters of the similarity warp motion model include a first pair of parameters (h₁₃, h₂₃) that represent translational motion (translational parameters), such as a horizontal translational motion parameter (h₁₃) and a vertical translational motion parameter (h₂₃). The parameters of the similarity warp motion model include a second parameter (hi) that represents scaling (scaling parameter) (h₂₂=h₁₁). The parameters of the similarity warp motion model include a third parameter (h₂₁) that, in conjunction with the scaling parameter, represents angular rotation (rotation parameter) (h₁₂=h₂₁). For example, for a current pixel at position (x, y) from the current frame, a corresponding position (x′, y′) from the reference frame may be indicated using the similarity warp motion model, which may include a horizontal displacement (x′) for encoding the current block that is a result of adding a result of subtracting a result of multiplying the rotation parameter by the current vertical position, from a result of multiplying the horizontal scaling parameter by the current horizontal position, and the horizontal translational motion parameter, and a vertical displacement (y′) for encoding the current block that is a result of adding a result of multiplying the rotation parameter by the current horizontal position, a result of multiplying the horizontal scaling parameter by the current vertical position, and the vertical translational motion parameter, which may be expressed as the following:

$${x}^{′} = {h}_{11} x - {h}_{21} y + {h}_{13} , \qquad [ Equation 3 ]$$

$${y}^{′} = {h}_{21} x + {h}_{11} y + {h}_{23} . \qquad [ Equation 4 ]$$

The parameters of a warp motion model, other than the translational parameters, are non-translational warp motion model parameters.

Block-based hybrid video coding techniques may include warped motion video coding using a global warp motion model, a local warp motion model, or both.

In some implementations, a global warp model, which may represent frame level scaling and rotation, which may correspond with rigid motion, which may be associated with a respective reference frame, may be used, which may include expressing the non-translational parameters (h₁₁, h₁₂, h₂₁, h₂₂) with twelve-bit (12-bit) precision and expressing the translational parameters (h₁₃, h₂₃) with fifteen-bit (15-bit) precision.

In some implementations, a local, block level or causal, warp model (WARP_CAUSAL) may be used. In local warp mode, the warp motion model parameters of the current block are obtained, or derived, by fitting a model to context motion vectors using least-squares. In some implementations, signaling the warp motion model parameters in local warp mode may be omitted, avoided, or excluded.

In an example, in the local warp mode (WARP_CAUSAL), for the current block, a motion vector indicating translational motion is signaled in the encoded bitstream. Rotation and scaling parameters are derived from neighboring motion vectors. The warp motion model parameters are obtained, such as determined or calculated, such as using mean-squared minimization of difference between the reference and modeled projections (projected points in the reference frame) based on motion vectors for the current block and its adjacent neighboring blocks. To obtain the parameters of local warped motion, wherein the current block is coded with respect to a reference frame, for a respective neighboring block coded with respect to the reference frame of the current block, a projection sample pair of a center sample in the neighboring block and a corresponding sample in the reference frame is obtained. The motion vectors of neighboring blocks that refer to the reference frame for the current block are used as motion samples to derive the warp motion model parameters. Warped motion prediction mode may be disabled for compound prediction.

In some implementations, warped motion may be coded using an extended warp mode (WARP_EXTEND). In the extended warp mode, a warp motion model is constructed by smoothly extending the motion of the context blocks into the current block, with modification based on a signaled motion vector.

In some implementations, warped motion may be coded using a differential warp motion mode (WARP_DELTA). In the differential warp motion mode (WARP_DELTA), a warp reference list (WRL) is generated from neighboring blocks, such as previously coded, or context, blocks, coded using a warp model. Predicted warp motion model parameters for the current block are obtained from the warp reference list. In some implementations, differential warp motion model parameters indicating a difference between the current, or optimal, warp motion model parameters for the current block and the predicted warp motion model parameters, may be signaled.

In some implementations, generating the warp reference list includes predicting warp motion model parameters from spatially neighboring blocks, predicting warp motion model parameters from a warp parameter bank, predicting warp motion model parameters from the global motion model, and using defined warp parameter values.

In some implementations, generating the warp reference list includes deriving a warp model from corner context blocks, predicting warp motion model parameters from spatially neighboring blocks, predicting warp motion model parameters from a warp parameter bank, predicting warp motion model parameters from the global motion model, and using defined warp parameter values.

Encoding using compound warp inter-intra prediction 700 includes obtaining a current block (at 710), signaling compound warp inter-intra mode data (at 720), generating intra prediction block data (at 730), signaling intra prediction mode data (at 740), generating warp inter prediction block data (at 750), obtaining predicted block data (at 760), obtaining encoded block data (at 770), and outputting an encoded bitstream (at 780).

The current frame is obtained (at 710). The current frame is a frame from the input video, or input video stream. In some implementations, the input video stream may include one or more sequences of frames. A sequence of frames may have a defined cardinality, or number, of frames. For example, the encoder, or a component thereof, such as an intra/inter prediction unit of the encoder, such as the intra/inter prediction unit 410 shown in FIG. 4, may obtain the input video stream. The current frame may be obtained (at 710) subsequent to encoding one or more other frames, such as a frame sequentially preceding the current frame in the input video stream, and generating, or otherwise obtaining, a corresponding reconstructed frame (or frames), or one or more portions thereof, for use as a reference frame (or frames) for encoding the current frame.

The current block is obtained (at 710) from the current frame. Although not shown separately in FIG. 7, encoding using compound warp inter-intra prediction 700 may include encoding, reconstructing, or both, one or more portions of the current frame prior to encoding the current block.

Mode data for encoding the current block is obtained. Obtaining the mode data includes obtaining, determining, or otherwise identifying prediction mode data for the current block. The prediction mode data for the current block indicates whether the prediction mode for the current block is an intra prediction mode, an inter prediction mode, or a compound prediction mode, such as the compound warp inter-intra prediction mode. For encoding using compound warp inter-intra prediction 700, the prediction mode data for the current block indicates that the prediction mode for the current block is the compound warp inter-intra prediction mode.

Obtaining the mode data includes obtaining, determining, or otherwise identifying motion mode data for the current block. In some implementations, obtaining, identifying, or determining, the motion mode data (motion mode) for the current block includes determining whether to encode the current block using a motion mode from one or more candidate motion modes including the causal warp motion mode (WARP_CAUSAL), the extended warp motion mode (WARP_EXTEND), the differential warp motion mode (WARP_DELTA), or the warp motion vector prediction mode (WARPMV).

The respective rate-distortion error for respective candidate motion modes are determined. The rate-distortion error for a respective motion mode represents the rate cost of encoding the block using the respective motion mode as compared to the distortion cost for encoding the block using the respective motion mode. The motion mode corresponding to the minimal rate-distortion error is identified as the motion mode for the current block.

Although not expressly shown in FIG. 7, the encoder may signal, such as in the encoded bitstream, warp prediction mode data indicating the warp prediction mode for the current block.

The encoder signals, such as includes in the encoded bitstream for the current block, compound warp inter-intra mode data (warp_inter_intra), such as a bit, flag, symbol, data element, or other syntax element, to indicate (warp_inter_intra==1) that the current block is coded using the compound warp inter-intra mode (at 720).

The encoder generates the intra prediction block data for the current block in accordance with intra prediction mode data for the current block (at 730). The intra prediction mode data indicates an intra prediction mode identified, by the encoder, from among a defined set, or plurality, of available intra prediction modes. In some implementations, intra prediction mode data indicates an intra prediction mode identified, by the encoder, from among a defined proper subset of the defined set, or plurality, of available intra prediction modes, wherein the defined proper subset includes a direct current intra prediction mode (DC intra prediction mode), a horizontal intra prediction mode, a vertical intra prediction mode, and a smooth intra prediction mode.

The encoder signals, such as includes in the encoded bitstream for the current block, the intra prediction mode data indicating the intra prediction mode for the current block (at 740).

The encoder generates the warp inter prediction block data for the current block (at 750).

In some implementations, generating the warp inter prediction block data for the current block (at 750) includes obtaining the warp reference list (WRL) for the current block. The warp reference list is a list, or array, of warp motion parameter sets obtained, generated, or otherwise accessed, from the context blocks for the current block.

In some implementations, the encoder signals, such as includes in the encoded bitstream, at least one bit, flag, symbol, data element, or other syntax element, to indicate the motion mode for the current block.

Generating the warp inter prediction block data for the current block includes obtaining a warp motion vector for encoding the current block and generating the warp inter prediction block data in accordance with the warp motion vector for encoding the current block. In some implementations, the encoder signals, such as includes in the encoded bitstream, one or more portions of the warp motion vector for encoding the current block, such as the translational components of the warp motion vector for encoding the current block. Other warp motion data may be signaled.

Obtaining the warp motion vector for the current block includes obtaining a warp motion vector prediction for the current block. In some implementations, the motion vector prediction for the current block is obtained, such as derived, from the warp reference list, such as in accordance with a warp model, or warp motion parameter set, indicated by a current warp reference list index value (predicted warp motion model parameters).

To obtain, or identify, the current warp motion model parameters for the current block, the encoder may search, or evaluate, parameter values around the predicted warp motion model parameters, such as using a spiral search or a gradient descent search. At a respective search point, the encoder may determine a corresponding rate-distortion metric, or cost. The encoder may identify the parameters corresponding to the minimal rate-distortion cost as the current, or optimal, warp motion model parameters for the current block.

The predicted block data (compound warp inter-intra prediction block data) is obtained (at 760) by combining the warp inter prediction block data and the intra prediction block data.

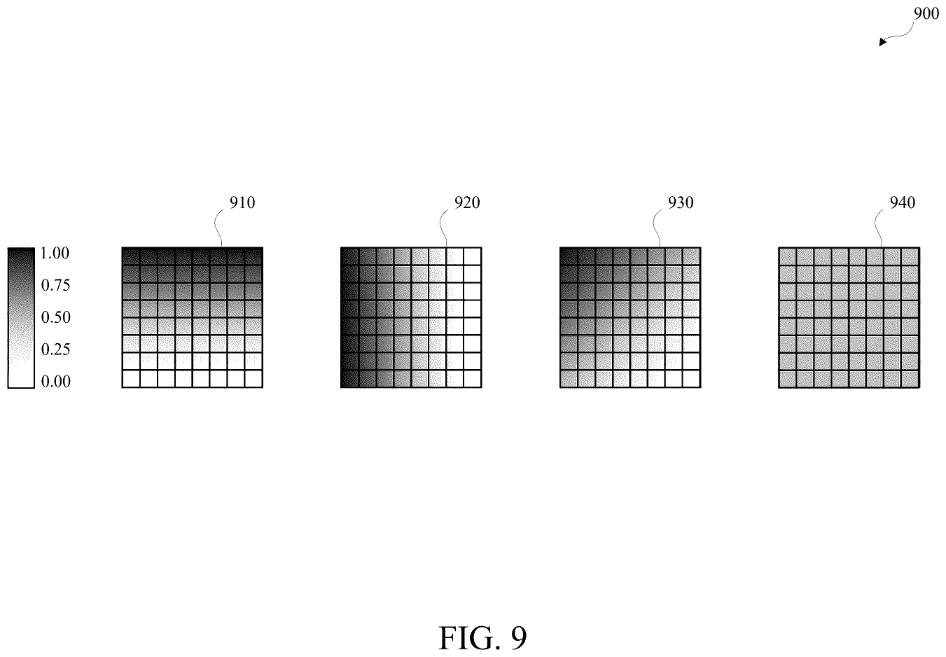

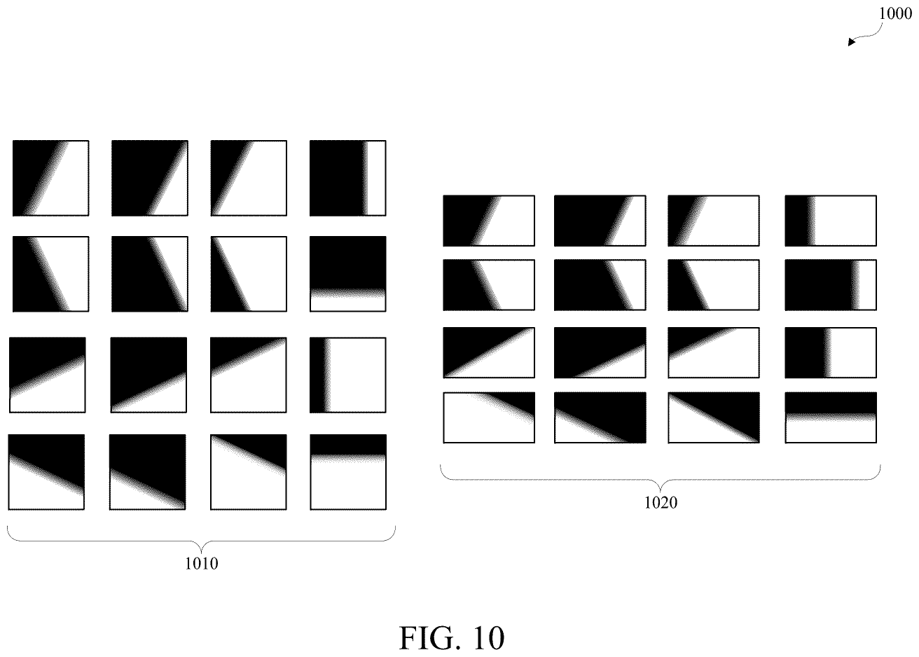

Obtaining the predicted block data (at 760) includes identifying, as a mask mode for the current block, a wedge mask mode (wedge masking) or a uniform mask mode (uniform masking). An example of uniform mask mode is shown in FIG. 9. An example of wedge mask mode is shown in FIG. 10.

Obtaining the predicted block data (at 760) includes identifying mask mode data indicating the mask mode for the current block.

Obtaining the predicted block data (at 760) includes signaling, such as including in the encoded bitstream for the current block, the mask mode data indicating the mask mode for the current block. In some implementations, signaling the mask mode data includes signaling a bit, flag, symbol, data element, or other syntax element, indicating the mask mode data (wedge_inter_intra). For example, the mask mode data may have the value one (wedge_inter_intra==1) indicating that the mask mode for the current block is the wedge mask mode. In another example, the mask mode data may have the value zero (wedge_inter_intra==0) indicating that the mask mode for the current block is the uniform mask mode.

In some implementations, combining the warp inter prediction block data and the intra prediction block data includes, in response to the mask mode data indicating that mask mode is the wedge mask mode, including, in the encoded bitstream, wedge mask index data indicating a wedge mask index value for coding the current block. The encoder generates wedge mask data in accordance with the wedge mask index value. The wedge mask index value indicates a wedge mask type from a defined plurality of wedge mask types as shown in FIG. 10.

The encoder generates the predicted block data by combining the warp inter prediction block data and the intra prediction block data in accordance with the wedge mask data.

In some implementations, combining the warp inter prediction block data and the intra prediction block data includes, in response to the mask mode data indicating that mask mode is a uniform mask mode, obtaining uniform mask data and generating the predicted block data (compound warp inter-intra prediction block data) by combining the warp inter prediction block data and the intra prediction block data in accordance with the uniform mask data.

In some implementations, obtaining the uniform mask data includes obtaining, as the uniform mask data, mode dependent uniform mask data identified in accordance with the intra prediction mode data, as shown in FIG. 9.

In some implementations, generating the predicted block data includes obtaining a weighting matrix from the uniform mask data, wherein the weighting matrix indicates respective weight values on a per-pixel position basis. Generating the predicted block data includes obtaining, as the predicted block data, a sum of adding a result of multiplying the warp inter prediction block data by a result of subtracting the weighting matrix from one and a result of multiplying the intra prediction block data by the weighting matrix.

In some implementations, encoding the current block includes identifying the intra prediction mode from a defined proper subset of available intra prediction modes, wherein the defined subset includes a DC intra prediction mode, a vertical intra prediction mode, a horizontal intra prediction mode, and a smooth intra prediction mode.

The encoded block data is obtained (at 770). Obtaining the encoded block data for the current block includes obtaining residual block data for the current block indicating a difference between the predicted block data for the current block and the current, or input, block data for the current block. Obtaining the encoded block data for the current block includes signaling, such as including in the encoded bitstream for the current block, encoded residual block data obtained by encoding the residual block data.

The encoded block data is included in encoded bitstream and the encoded bitstream is output (at 780).

Although not shown separately in FIG. 7, in some implementations, prior to encoding the current frame, or a block thereof, the encoder may signal, such as include in the encoded bitstream, a frame level flag, bit, symbol, data element, or other syntax element, to indicate whether the compound warp inter-intra mode is enabled, available, or usable, for the current frame or is disabled, unavailable, or unusable for the current frame.

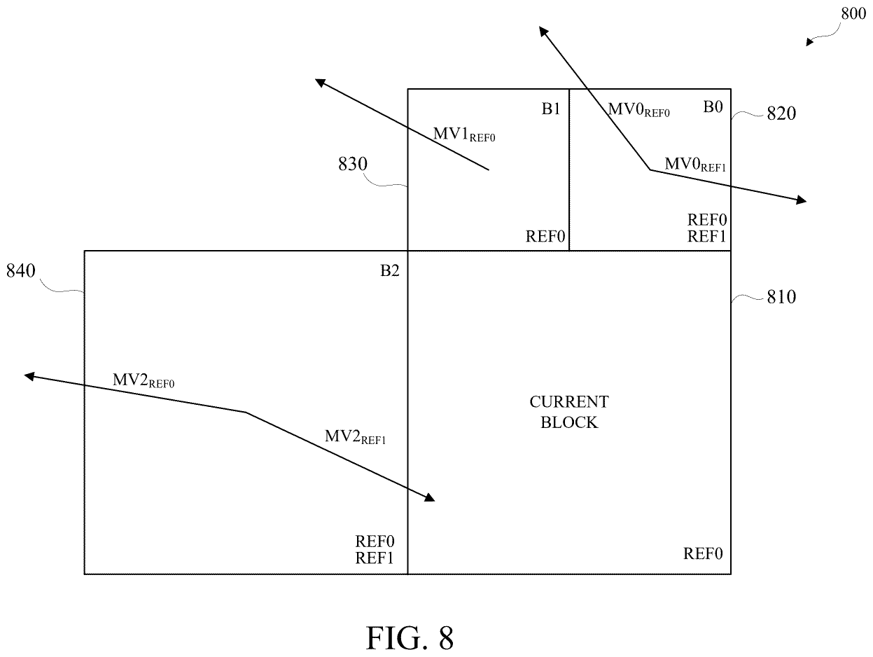

FIG. 8 is a block diagram of an example of warp mode 800. FIG. 8 shows a current block 810, a top right above context block (B0) 820, a top left above context block (B1) 830, and a left context block (B2) 840.

The current block 810 is predicted using uni-prediction with a first reference frame (REF0).

The top right above neighboring, or context, block (B0) 820 is predicted using compound prediction with the first reference frame (REF0) and a second reference frame (REF1). The top right above neighboring, or context, block (B0) 820 includes a first motion vector (MV0_{REF0}) indicating the first reference frame (REF0) and a second motion vector (MV0_{REF1}) indicating a second reference frame (REF1). The motion vectors (MV0_{REF0}, MV0_{REF1}) of the top right above neighboring, or context, block (B0) 820 are neighboring, or context, motion vectors for coding the current block 810.

The top left above neighboring, or context, block (B1) 830 is predicted using uni-prediction and includes a motion vector (MV1_{REF0}) indicating the first reference frame (REF0). The motion vector (MV1_{REF0}) of the top left above neighboring, or context, block (B1) 830 are neighboring, or context, motion vectors for coding the current block 810.

The left neighboring, or context, block (B2) 840 is predicted using compound prediction and includes a first motion vector (MV2_{REF0}) indicating the first reference frame (REF0) and a second motion vector (MV2_{REF2}) indicating a second reference frame (REF1). The motion vectors (MV2_{REF0}, MV2_{REF2}) of the left neighboring, or context, block (B2) 840 are neighboring, or context, motion vectors for coding the current block 810.

In some implementations, the translational components of a warp motion vector (translational warp model parameters) may be signaled, such as included in the encoded bitstream. The non-translational components of a warp motion vector (non-translational warp model parameters) may be derived from the neighboring, or context, motion vectors.

In some implementations, the current block 810 may be coded using local warped motion and the warp model parameters may be estimated, such as using mean-squared minimization of a difference between the reference and modeled projections based on the motion vectors of the current block 810 and the adjacent neighboring blocks 820, 830, 840. To estimate the parameters of local warped motion, such as wherein the neighboring blocks 820, 830, 840 use the same reference frame (REF0) as the current block 810, a projection sample pair of a center sample in the neighboring blocks 820, 830, 840 and its corresponding sample in the reference frame is obtained. The motion vectors of the neighboring blocks 820, 830, 840, which may be used to derive the motion parameters, may be referred to as motion samples. The motion samples are selected from the neighboring blocks 820, 830, 840 that use the reference frame of the current block 810 (REF0).

The motion vector (MV0Ref0) of the top right above neighboring, or context, block (B0) 820, the motion vector (MV1Ref0) of the top left above neighboring, or context, block (B1) 830, and the motion vector (MV2Ref0) of the left neighboring, or context, block (B2) 840 can be used as the motion samples for deriving the affine motion parameters of the current block 810.

FIG. 9 is a block diagram of an example of obtaining compound warp inter-intra prediction block data using uniform mask mode 900.

Obtaining compound warp inter-intra prediction block data using uniform mask mode 900 includes obtaining, as the compound warp inter-intra prediction block data (P), a weighted, such as in accordance with uniform mask data (w), average of the warp inter prediction block data (P1) and the intra prediction block data (P2). For example, the compound warp inter-intra prediction block data (P) may be a sum of adding a result of multiplying the warp inter prediction block data (P1) by a result of subtracting the weighting matrix from one (1−w) and a result of multiplying the intra prediction block data (P2) by the weighting matrix (w), which may be expressed as the following:

$$P = ( 1 - w ) * P 1 + w * P 2 .$$

The uniform mask data (w) may be, or include, a defined or derived weighting matrix having the size of the current block, wherein the weighting matrix indicates respective weight values on a per-pixel position basis. In some implementations, the weighting values may be in a range from zero (0) to one (1). The weighting values may indicate the contribution of the intra prediction block data (P2) to the compound warp inter-intra prediction block data (P) for a respective pixel position.

In some implementations, the accuracy of the intra prediction block data (P2) is correlated to the distance from the context block from which the intra prediction block data (P2) is predicted, such as from above and to the left of the current block and the weighting values corresponding to pixels relatively near the context block from which the intra prediction block data (P2) is predicted, such as pixels in the top-left corner of the current block, may give high weight, such as one hundred percent weight, to the intra prediction block data (P2). Pixels relatively far from the context block from which the intra prediction block data (P2) is predicted may have relatively high weight, such as one hundred percent weight, to the warp inter prediction block data (P1).

In some implementations, the weighting matrix may be mode dependent uniform mask data identified, selected, or determined, in accordance with the intra prediction mode direction.

For example, FIG. 9 shows a first, vertical, weighting matrix 910, for vertical intra prediction, or relatively vertical directional intra prediction modes, wherein pixel locations shown with relatively dark backgrounds, such as in the top row, correspond to a weighting value of one (w=1.00), or one hundred percent, and pixel locations shown with relatively light backgrounds, such as in the bottom row, correspond to a weighting value of zero (w=0.00), or zero percent.

In another example, FIG. 9 shows a second, horizontal, weighting matrix 920, for horizontal intra prediction, or relatively horizontal directional intra prediction modes, wherein pixel locations shown with relatively dark backgrounds, such as in the left column, correspond to a weighting value of one (w=1.00), or one hundred percent, and pixel locations shown with relatively light backgrounds, such as in the right column, correspond to a weighting value of zero (w=0.00), or zero percent.

In another example, FIG. 9 shows a third, smooth, weighting matrix 930, for smooth intra prediction, wherein pixel locations shown with relatively dark backgrounds, such as in the top-left corner, correspond to a weighting value of one (w=1.00), or one hundred percent, and pixel locations shown with relatively light backgrounds, such as in the bottom right, correspond to a weighting value of zero (w=0.00), or zero percent. In smooth intra prediction mode, values are predicted using an average of quadratic interpolation horizontally and vertically.

In another example, FIG. 9 shows a fourth, DC, weighting matrix 940, for DC intra prediction, wherein weighting values are 0.50.

In some implementations, multiple defined weights may be used per block. The encoder may evaluate respective values from the multiple defined weights and determine an optimal weighting matrix (mask). The encoder may signal, such as in the encoded bitstream, the optimal weighting matrix (mask).

In some implementations, the encoder may signal, such as in the encoded bitstream, weighting values.

FIG. 10 is a block diagram of an example of obtaining compound warp inter-intra prediction block data using wedge mask mode 1000.

Obtaining compound warp inter-intra prediction block data using wedge mask mode 1000 includes obtaining, as the compound warp inter-intra prediction block data (P), a weighted, such as in accordance with wedge mask data, combination, such as an average, of the warp inter prediction block data (P1) and the intra prediction block data (P2).

Obtaining compound warp inter-intra prediction block data (P) using wedge mask mode 1000 includes dividing the compound warp inter-intra prediction block into two regions, or portions, (shown as having a black background and a white background, respectively, in FIG. 10). A first portion, or region, of the compound warp inter-intra prediction block data (shown with a black background) is predicted in accordance with the warp inter prediction block data (P1). A second portion, or region, of the compound warp inter-intra prediction block (shown with a white background) is predicted in accordance with the intra prediction block data (P2). Predictions along the border between the first region and the second region are shown with a gray background to indicate that such predictions are obtained by blending the warp inter prediction block data (P1) and the intra prediction block data (P2).

FIG. 10 shows a first set, or defined plurality, of wedge mask types for square blocks 1010 and a second set, or defined plurality, of wedge mask types for horizontal rectangular blocks 1020. Other wedge mask types may be used. The encoder selects, determines, or otherwise identifies a wedge mask type, which may include identifying an index value (wedge mask index value or wedge mask index data) of the wedge mask in the set of wedge mask types, based on minimizing rate-distortion cost.

In some implementations, the encoder obtains, reads, or accesses, the values of a respective wedge mask from stored data. In some implementations, the encoder obtains, generates, calculates, or otherwise determines the values of a respective wedge mask mathematically.

The encoder may signal the wedge mask type, such as an index value for the wedge mask type, such as in the encoded bitstream.

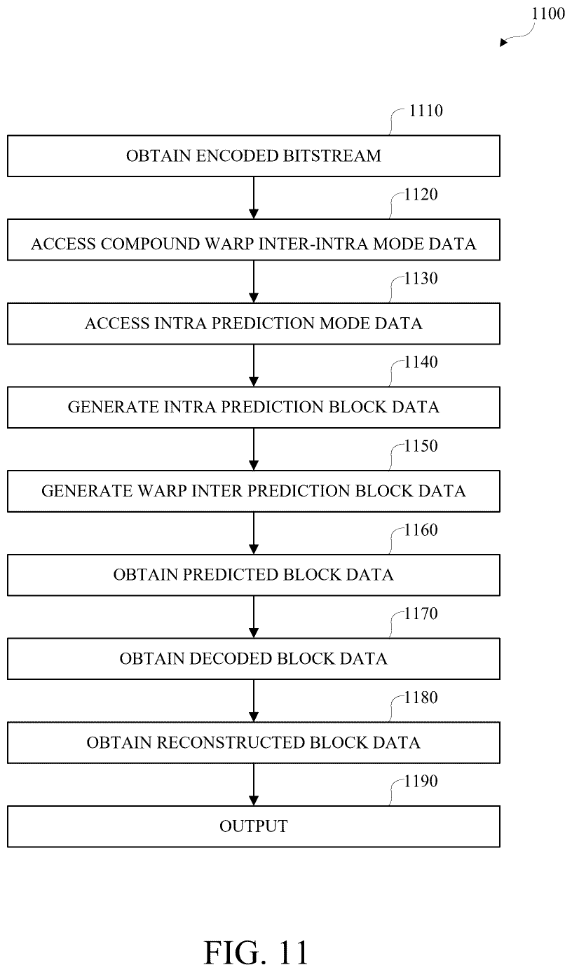

FIG. 11 is a flowchart diagram of an example of decoding using compound warp inter-intra prediction 1100 in accordance with implementations of this disclosure. Decoding using compound warp inter-intra prediction 1100 may be implemented in a decoder, such as the decoder 500 shown in FIG. 5.

Decoding using compound warp inter-intra prediction 1100 includes obtaining reconstructed block data for a current block of a current frame of a sequence of frames by decoding an encoded bitstream, such as the compressed bitstream 502 shown in FIG. 5, or one or more portions thereof, to generate a reconstructed video, or a portion thereof, such as the output video stream 504 shown in FIG. 5.

The decoder may maintain, such as store in local memory, such as in a decoded frame buffer (or reference frame buffer, or reconstructed frame buffer), one or more reconstructed frames, which may be used as reference frames for inter prediction, which is similar to the reconstructed frame buffer maintained by the encoder as described with reference to FIG. 7, except as is described herein or as is otherwise clear from context.

Decoding using compound warp inter-intra prediction 1100 includes obtaining the encoded bitstream (at 1110), accessing compound warp inter-intra mode data (at 1120), accessing intra prediction mode data (at 1130), generating intra prediction block data (at 1140), generating warp inter prediction block data (at 1150), obtaining predicted block data (at 1160), obtaining decoded block data (at 1170), obtaining reconstructed block data (at 1180), and outputting the reconstructed block (at 1190).

The encoded bitstream is obtained (at 1110). Obtaining the encoded bitstream includes identifying a current frame to decode from the encoded bitstream to generate a current reconstructed frame, which includes identifying a current block from the current frame to decode from the encoded bitstream to generate a current reconstructed block to include in the current reconstructed frame. For example, the decoder, or a component thereof, such as an intra/inter prediction unit of the decoder, such as the entropy decoding unit 510 shown in FIG. 5, may obtain the input video stream. The current frame may be obtained (at 1110) subsequent to decoding one or more other frames, such as a frame sequentially preceding the current frame, and generating, or otherwise obtaining, a corresponding reconstructed frame (or frames), or one or more portions thereof, for use as a reference frame (or frames) for decoding the current frame. Although not shown separately in FIG. 11, decoding using compound warp inter-intra prediction 1100 may include decoding, reconstructing, or both, one or more portions of the current frame prior to decoding, reconstructing, or both, the current block.

Decoding using compound warp inter-intra prediction 1100 includes accessing, reading, extracting, decoding, such as entropy decoding, or otherwise obtaining, from the encoded bitstream, the compound warp inter-intra mode data for the current block (at 1120). The compound warp inter-intra mode data indicates whether the current block is coded using compound warp inter-intra mode. For decoding using compound warp inter-intra prediction 1100 the compound warp inter-intra mode data indicates that the current block is coded using compound warp inter-intra mode (warp_inter_intra==1).

Decoding using compound warp inter-intra prediction 1100 includes accessing, reading, extracting, decoding, such as entropy decoding, or otherwise obtaining, from the encoded bitstream, intra prediction mode data indicating an intra prediction mode for the current block (at 1130).

Decoding using compound warp inter-intra prediction 1100 includes generating, determining, calculating, or otherwise obtaining, intra prediction block data for the current block in accordance with the intra prediction mode data (at 1140).

Although not shown expressly in FIG. 11, decoding using compound warp inter-intra prediction 1100 includes accessing, reading, extracting, decoding, such as entropy decoding, or otherwise obtaining, from the encoded bitstream, such as prior to accessing the compound warp inter-intra mode data, warp mode data indicating a warp inter prediction mode for the current block. In some implementations, decoding using compound warp inter-intra prediction 1100 includes accessing, reading, extracting, decoding, such as entropy decoding, or otherwise obtaining, from the encoded bitstream, such as prior to accessing the compound warp inter-intra mode data, warp parameter data including one or more warp parameters (warp inter prediction parameters) for predicting the current block. Other data for warped prediction for the current block may be included in the encoded bitstream.

Decoding using compound warp inter-intra prediction 1100 includes generating, determining, calculating, or otherwise obtaining, warp inter prediction block data for the current block (at 1150), such as in accordance with the warp inter prediction mode for the current block, such as using the warp inter prediction parameters.

Decoding using compound warp inter-intra prediction 1100 includes determining, calculating, or otherwise obtaining, predicted block data (at 1160) for the current block by combining the warp inter prediction block data and the intra prediction block data.

Combining the warp inter prediction block data and the intra prediction block data (at 1160) includes accessing, reading, extracting, decoding, such as entropy decoding, or otherwise obtaining, from the encoded bitstream, mask mode data indicating a mask mode for the current block.

Combining the warp inter prediction block data and the intra prediction block data (at 1160) includes determining whether the mask mode data indicates that mask mode is a wedge mask mode.

Combining the warp inter prediction block data and the intra prediction block data (at 1160) includes, in response to the mask mode data indicating that mask mode is a wedge mask mode, accessing, reading, extracting, decoding, such as entropy decoding, or otherwise obtaining, from the encoded bitstream, wedge mask index data indicating a wedge mask index value for coding the current block.

Combining the warp inter prediction block data and the intra prediction block data (at 1160) includes accessing, such as by reading, or generating wedge mask data in accordance with the wedge mask index value.

Combining the warp inter prediction block data and the intra prediction block data (at 1160) includes generating, determining, calculating, or otherwise obtaining, the predicted block data by combining the warp inter prediction block data and the intra prediction block data in accordance with the wedge mask data.

In some implementations, the wedge mask index value indicates a wedge mask type from a defined plurality of wedge mask types, such as shown in FIG. 10.

In some implementations, the wedge mask data indicates a first portion of the predicted block data for prediction in accordance with the warp inter prediction block data. In some implementations, the wedge mask data indicates a second portion of the predicted block data for prediction in accordance with the intra prediction block data.

In some implementations, combining the warp inter prediction block data and the intra prediction block data includes determining whether the mask mode data indicates that mask mode is a uniform mask mode or a wedge mask mode.

In some implementations, combining the warp inter prediction block data and the intra prediction block data includes, in response to the mask mode data indicating that mask mode is a uniform mask mode, obtaining uniform mask data and generating, determining, calculating, or otherwise obtaining, the predicted block data by combining the warp inter prediction block data and the intra prediction block data in accordance with the uniform mask data.

In some implementations, obtaining the uniform mask data includes obtaining, as the uniform mask data, mode dependent uniform mask data identified in accordance with the intra prediction mode data, such as shown in FIG. 9.

In some implementations, generating, determining, calculating, or otherwise obtaining, the predicted block data includes obtaining a weighting matrix from the uniform mask data, wherein the weighting matrix indicates respective weight values on a per-pixel position basis. In some implementations, generating, determining, calculating, or otherwise obtaining, the predicted block data includes obtaining, as the predicted block data, a sum of adding a result of multiplying the warp inter prediction block data by a result of subtracting the weighting matrix from one and a result of multiplying the intra prediction block data by the weighting matrix.

Decoding using compound warp inter-intra prediction 1100 includes determining, calculating, or otherwise obtaining, decoded block data (at 1170). Obtaining the decoded block data (at 1170) may include accessing, reading, extracting, decoding, such as entropy decoding, or otherwise obtaining, from the encoded bitstream, encoded block data for the current block. Obtaining the decoded block data (at 1170) may include obtaining the decoded block data (residual block) by decoding, reading, extracting, or otherwise accessing, the encoded block data from the encoded bitstream and decoding, such as entropy decoding, the encoded block data.

Decoding using compound warp inter-intra prediction 1100 includes determining, calculating, or otherwise obtaining, reconstructed block data (at 1180). Obtaining the reconstructed block data (at 1180) may include including, in the reconstructed block data, a sum of the decoded block data and the predicted block data (compound warp inter-intra prediction block data). Obtaining the reconstructed block data may include aspects not expressly shown in FIG. 11 for simplicity, such as filtering, such as the filtering shown (at 560) in FIG. 5.

Decoding using compound warp inter-intra prediction 1100 includes outputting the reconstructed block (at 1190), such as by including the reconstructed block data in reconstructed frame data and including the reconstructed frame data in the output.

In some implementations, an encoded bitstream generated, or obtained, using compound warp inter-intra prediction includes compound warp inter-intra mode data indicating that a current block of a current frame of a sequence of frames is coded using compound warp inter-intra mode. The encoded bitstream generated, or obtained, using compound warp inter-intra prediction includes intra prediction mode data indicating an intra prediction mode for coding the current block. The encoded bitstream generated, or obtained, using compound warp inter-intra prediction includes mask mode data indicating a mask mode for coding the current block.

In some implementations, the mask mode data indicates that the mask mode for the current block is a wedge mask mode and the encoded bitstream includes wedge mask index data indicating a wedge mask index value for coding the current block by generating intra prediction block data for the current block in accordance with the intra prediction mode data, generating warp inter prediction block data for the current block, generating wedge mask data in accordance with the wedge mask index value, generating predicted block data by combining the warp inter prediction block data and the intra prediction block data in accordance with the wedge mask data, obtaining decoded block data by decoding encoded block data accessed from the encoded bitstream, including, in reconstructed block data for the current block, a sum of the decoded block data and the predicted block data, and including the reconstructed block data in reconstructed frame data for the current frame.

In some implementations, the mask mode data indicates that the mask mode for the current block is a uniform mask mode for coding the current block by generating intra prediction block data for the current block in accordance with the intra prediction mode data, generating warp inter prediction block data for the current block, obtaining uniform mask data, generating predicted block data by combining the warp inter prediction block data and the intra prediction block data in accordance with the uniform mask data, obtaining decoded block data by decoding encoded block data accessed from the encoded bitstream, including, in reconstructed block data for the current block, a sum of the decoded block data and the predicted block data, and including the reconstructed block data in reconstructed frame data for the current frame.

As used herein, the terms “optimal”, “optimized”, “optimization”, or other forms thereof, are relative to a respective context and are not indicative of absolute theoretic optimization unless expressly specified herein.

As used herein, the term “set” indicates a distinguishable collection or grouping of zero or more distinct elements or members that may be represented as a one-dimensional array or vector, except as expressly described herein or otherwise clear from context.

The words “example” or “exemplary” are used herein to mean serving as an example, instance, or illustration. Any aspect or design described herein as “example” or “exemplary” not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an embodiment” or “one embodiment” or “an implementation” or “one implementation” throughout is not intended to mean the same embodiment or implementation unless described as such. As used herein, the terms “determine” and “identify”, or any variations thereof, includes selecting, ascertaining, computing, looking up, receiving, determining, establishing, obtaining, or otherwise identifying or determining in any manner whatsoever using one or more of the devices shown in FIG. 1.

Further, for simplicity of explanation, although the figures and descriptions herein may include sequences or series of steps or stages, elements of the methods disclosed herein can occur in various orders and/or concurrently. Additionally, elements of the methods disclosed herein may occur with other elements not explicitly presented and described herein. Furthermore, one or more elements of the methods described herein may be omitted, avoided, or excluded from implementations of methods in accordance with the disclosed subject matter.

The implementations of the transmitting computing and communication device 100A and/or the receiving computing and communication device 100B (and the algorithms, methods, instructions, etc. stored thereon and/or executed thereby) can be realized in hardware, software, or any combination thereof. The hardware can include, for example, computers, intellectual property (IP) cores, application-specific integrated circuits (ASICs), programmable logic arrays, optical processors, programmable logic controllers, microcode, microcontrollers, servers, microprocessors, digital signal processors or any other suitable circuit. In the claims, the term “processor” should be understood as encompassing any of the foregoing hardware, either singly or in combination. The terms “signal” and “data” are used interchangeably. Further, portions of the transmitting computing and communication device 100A and the receiving computing and communication device 100B do not necessarily have to be implemented in the same manner.

Further, in one implementation, for example, the transmitting computing and communication device 100A or the receiving computing and communication device 100B can be implemented using a computer program that, when executed, carries out any of the respective methods, algorithms and/or instructions described herein. In addition, or alternatively, for example, a special purpose computer/processor can be utilized which can contain specialized hardware for carrying out any of the methods, algorithms, or instructions described herein.

The transmitting computing and communication device 100A and receiving computing and communication device 100B can, for example, be implemented on computers in a real-time video system. Alternatively, the transmitting computing and communication device 100A can be implemented on a server and the receiving computing and communication device 100B can be implemented on a device separate from the server, such as a hand-held communications device. In this instance, the transmitting computing and communication device 100A can encode content using an encoder 400 into an encoded video signal and transmit the encoded video signal to the communications device. In turn, the communications device can then decode the encoded video signal using a decoder 500. Alternatively, the communications device can decode content stored locally on the communications device, for example, content that was not transmitted by the transmitting computing and communication device 100A. Other suitable transmitting computing and communication device 100A and receiving computing and communication device 100B implementation schemes are available. For example, the receiving computing and communication device 100B can be a generally stationary personal computer rather than a portable communications device and/or a device including an encoder 400 may also include a decoder 500.

Further, all or a portion of implementations can take the form of a computer program product accessible from, for example, a tangible computer-usable or computer-readable medium. A computer-usable or computer-readable medium can be any device that can, for example, tangibly contain, store, communicate, or transport the program for use by or in connection with any processor. The medium can be, for example, an electronic, magnetic, optical, electromagnetic, or a semiconductor device. Other suitable mediums are also available.

It will be appreciated that aspects can be implemented in any convenient form. For example, aspects may be implemented by appropriate computer programs which may be carried on appropriate carrier media which may be tangible carrier media (e.g. disks) or intangible carrier media (e.g. communications signals). Aspects may also be implemented using suitable apparatus which may take the form of programmable computers running computer programs arranged to implement the methods and/or techniques disclosed herein. Aspects can be combined such that features described in the context of one aspect may be implemented in another aspect.

The above-described implementations have been described in order to allow easy understanding of the application are not limiting. On the contrary, the application covers various modifications and equivalent arrangements included within the scope of the appended claims, which scope is to be accorded the broadest interpretation so as to encompass all such modifications and equivalent structure as is permitted under the law.

What is claimed is:

1. A method comprising:
obtaining reconstructed block data for a current block of a current frame of a sequence of frames, wherein obtaining the reconstructed block data includes:
accessing, from an encoded bitstream, compound warp inter-intra mode data indicating that the current block is coded using compound warp inter-intra mode;
accessing, from the encoded bitstream, intra prediction mode data indicating an intra prediction mode for the current block;
generating intra prediction block data for the current block in accordance with the intra prediction mode data;
generating warp inter prediction block data for the current block;
obtaining predicted block data for the current block by combining the warp inter prediction block data and the intra prediction block data;
obtaining decoded block data by decoding encoded block data accessed from the encoded bitstream; and
including, in the reconstructed block data, a sum of the decoded block data and the predicted block data;
including the reconstructed block data in reconstructed frame data for the current frame; and
outputting the reconstructed frame data.

2. The method of claim 1, wherein combining the warp inter prediction block data and the intra prediction block data includes:
accessing, from the encoded bitstream, mask mode data indicating a mask mode for the current block.

3. The method of claim 2, wherein combining the warp inter prediction block data and the intra prediction block data includes:
in response to the mask mode data indicating that the mask mode is a wedge mask mode:
accessing, from the encoded bitstream, wedge mask index data indicating a wedge mask index value for coding the current block;
generating wedge mask data in accordance with the wedge mask index value; and
generating the predicted block data by combining the warp inter prediction block data and the intra prediction block data in accordance with the wedge mask data.

4. The method of claim 3, wherein:
the wedge mask index value indicates a wedge mask type from a defined plurality of wedge mask types.

5. The method of claim 3, wherein the wedge mask data indicates:
a first portion of the predicted block data for prediction in accordance with the warp inter prediction block data; and
a second portion of the predicted block data for prediction in accordance with the intra prediction block data.

6. The method of claim 2, wherein combining the warp inter prediction block data and the intra prediction block data includes:
in response to the mask mode data indicating that the mask mode is a uniform mask mode:
obtaining uniform mask data; and
generating the predicted block data by combining the warp inter prediction block data and the intra prediction block data in accordance with the uniform mask data.

7. The method of claim 6, wherein obtaining the uniform mask data includes:
obtaining, as the uniform mask data, mode dependent uniform mask data identified in accordance with the intra prediction mode data.

8. The method of claim 6, wherein generating the predicted block data includes:
obtaining a weighting matrix from the uniform mask data, wherein the weighting matrix indicates respective weight values on a per-pixel position basis; and
obtaining, as the predicted block data, a sum of adding a result of multiplying the warp inter prediction block data by a result of subtracting the weighting matrix from one and a result of multiplying the intra prediction block data by the weighting matrix.

9. A non-transitory computer-readable storage medium storing an encoded bitstream comprising:
compound warp inter-intra mode data indicating that a current block of a current frame of a sequence of frames is coded using compound warp inter-intra mode;
intra prediction mode data indicating an intra prediction mode for coding the current block; and
mask mode data indicating a mask mode for coding the current block.

10. The non-transitory computer-readable storage medium of claim 9, wherein:
the mask mode data indicates that the mask mode for the current block is a wedge mask mode; and
the encoded bitstream includes:
wedge mask index data indicating a wedge mask index value for coding the current block by:
generating intra prediction block data for the current block in accordance with the intra prediction mode data;
generating warp inter prediction block data for the current block;
generating wedge mask data in accordance with the wedge mask index value;
generating predicted block data by combining the warp inter prediction block data and the intra prediction block data in accordance with the wedge mask data;
obtaining decoded block data by decoding encoded block data accessed from the encoded bitstream;
including, in reconstructed block data for the current block, a sum of the decoded block data and the predicted block data; and
including the reconstructed block data in reconstructed frame data for the current frame.

11. The non-transitory computer-readable storage medium of claim 9, wherein:
the mask mode data indicates that the mask mode for the current block is a uniform mask mode for coding the current block by:
generating intra prediction block data for the current block in accordance with the intra prediction mode data;
generating warp inter prediction block data for the current block;
obtaining uniform mask data;
generating predicted block data by combining the warp inter prediction block data and the intra prediction block data in accordance with the uniform mask data;
obtaining decoded block data by decoding encoded block data accessed from the encoded bitstream;
including, in reconstructed block data for the current block, a sum of the decoded block data and the predicted block data; and
including the reconstructed block data in reconstructed frame data for the current frame.

12. A method comprising:
generating an encoded bitstream by encoding a current block from a current frame from an input video, wherein encoding the current block includes:
including, in the encoded bitstream, compound warp inter-intra mode data indicating that the current block is coded using compound warp inter-intra mode;
generating intra prediction block data for the current block in accordance with intra prediction mode data;
including, in the encoded bitstream, intra prediction mode data indicating an intra prediction mode for the current block;
generating warp inter prediction block data for the current block;
obtaining predicted block data for the current block by combining the warp inter prediction block data and the intra prediction block data;
obtaining encoded block data by encoding a difference between the predicted block data and current block data for the current block; and
including, in the encoded bitstream, the encoded block data; and
outputting the encoded bitstream.

13. The method of claim 12, wherein encoding the current block includes:
including, in the encoded bitstream, mask mode data indicating a mask mode for the current block.

14. The method of claim 13, wherein combining the warp inter prediction block data and the intra prediction block data includes:
in response to the mask mode data indicating that the mask mode is a wedge mask mode:
including, in the encoded bitstream, wedge mask index data indicating a wedge mask index value for coding the current block;
generating wedge mask data in accordance with the wedge mask index value; and
generating the predicted block data by combining the warp inter prediction block data and the intra prediction block data in accordance with the wedge mask data.

15. The method of claim 14, wherein:
the wedge mask index value indicates a wedge mask type from a defined plurality of wedge mask types.

16. The method of claim 14, wherein the wedge mask data indicates:
a first portion of the predicted block data for prediction in accordance with the warp inter prediction block data; and
a second portion of the predicted block data for prediction in accordance with the intra prediction block data.

17. The method of claim 13, wherein combining the warp inter prediction block data and the intra prediction block data includes:
in response to the mask mode data indicating that the mask mode is a uniform mask mode:
obtaining uniform mask data; and
generating the predicted block data by combining the warp inter prediction block data and the intra prediction block data in accordance with the uniform mask data.

18. The method of claim 17, wherein obtaining the uniform mask data includes:
obtaining, as the uniform mask data, mode dependent uniform mask data identified in accordance with the intra prediction mode data.

19. The method of claim 17, wherein generating the predicted block data includes:
obtaining a weighting matrix from the uniform mask data, wherein the weighting matrix indicates respective weight values on a per-pixel position basis; and
obtaining, as the predicted block data, a sum of adding a result of multiplying the warp inter prediction block data by a result of subtracting the weighting matrix from one and a result of multiplying the intra prediction block data by the weighting matrix.

20. The method of claim 17, wherein encoding the current block includes:
identifying the intra prediction mode from a defined proper subset of available intra prediction modes, wherein the defined proper subset includes a DC intra prediction mode, a vertical intra prediction mode, a horizontal intra prediction mode, and a smooth intra prediction mode.
